(19) United States
(12) Patent Application Publication
(10) Pub. No.: US 2017/0322714 A1
(43) Pub. Date: Nov. 9, 2017

(54) INFORMATION PROCESSING APPARATUS, INFORMATION PROCESSING METHOD, AND COMPUTER PROGRAM

(71) Applicant: SONY CORPORATION, TOKYO (JP)

(72) Inventors: KEISUKE SATO, TOKYO (JP); NAOMASA TAKAHASHI, CHIBA (JP); TOSHIMICHI HAMADA, TOKYO (JP)

(21) Appl. No.: 15/522,578

(22) PCT Filed: Jul. 31, 2015
(86) PCT No.: PCT/JP2015/071884

§ 371 Date: Apr. 27, 2017

(30) Foreign Application Priority Data
Nov. 11, 2014 (JP) 2014-228563

(51) Int. Cl. G06F 3/0484; G06T 11/20; G06F 3/0482

(52) U.S. Cl. CPC G06F 3/04847; G06F 3/0482; G06T 11/206

(57) ABSTRACT

To make it easy to select an optimal viewing environment depending on content and preference of each person when viewing an image with a head-mounted display or a large-screen display device. Evaluation values of respective elements of a visual effect with respect to viewing environments and image configurations are determined in advance. For example, when an observer tries to start image viewing, a viewing environment that is most likely to provide a desired visual effect is automatically extracted on the basis of the evaluation value determined in advance with respect to the viewing environment and the image configuration and parameters of that viewing environment are displayed in an easily understandable manner as GUIs. Further, the evaluation values of the elements of the viewing effect in the selected viewing environment are also displayed.

### TECHNICAL FIELD

The present technology disclosed herein relates to an information processing apparatus, an information processing method, and a computer program for processing information regarding a display method for an image, and more particularly to an information processing apparatus, an information processing method, and a computer program for processing information regarding a viewing environment of an image.

### BACKGROUND ART

Due to human visual performance, video viewing environments such as a size of a screen, a viewing distance, a look-up angle or look-down angle, and a viewing angle from a screen center vertical are important elements. The inventors consider that it is favorable that a content observer can freely select a viewing environment in a manner that depends on their preference.

If the screen is small, there are not many options of the viewing environments. As the screen becomes larger, the options of the viewing environments increase in contrast. Recently, display devices such as a television receiver and a projector have increased in size. Also in display devices such as a head-mounted display, an angle of visibility has increased. For example, there have been proposed right-eye and left-eye enlargement relay optical systems and a head-mounted display having a wide angle of visibility. The right-eye and left-eye enlargement relay optical systems project a virtual space image using computer graphics onto right-eye and left-eye screens, respectively. The head-mounted display having a wide angle of visibility projects transmission images of the screens onto the retinae of eyeballs via right-eye and left-eye eyepiece optical systems, respectively, as wide-area images having an angle of visibility of ±60 degrees or more with respect to both left and right eyes (e.g., see Patent Literature 1).

If content is displayed on a large screen, displaying an image on the entire screen is not necessarily an optimal viewing environment. Therefore, it is more desirable that an observer can freely select a viewing environment in a manner that depends on characteristics of content and individual preference of the observer.

For example, there has been proposed an image display apparatus with an increased fatigue resistance and an increased sense of presence by displaying an environmental image around a display (e.g., see Patent Literature 2). Further, there has been proposed an image processing apparatus. In the case of displaying a main image, which is a reproduction target, on a display screen larger than the main image, the image processing apparatus combines and displays the main image with a background image showing a theater as an object (e.g., see Patent Literature 3). However, the display method of combining the original image with the environmental image or the background image does not necessarily meet preference of each person. Further, it is difficult to say that it is a display method suitable for all content.

Further, there has been proposed a display apparatus capable of arbitrarily setting an observation position of an image in such a manner that a user selects a seat on a screen on which a seat map of a movie theater is displayed (e.g., see Patent Literature 4). However, it is difficult for users that are not professionals to determine which seat should be selected for obtaining a desired visual effect.

### DISCLOSURE OF INVENTION

### Technical Problem

It is an object of the technology disclosed herein to provide excellent information processing apparatus, information processing method, and computer program, by which information regarding a display method for an image can be suitably processed.

It is another object of the technology disclosed herein to provide excellent information processing apparatus, information processing method, and computer program, by which information regarding a suitable viewing environment can be suitably processed for display apparatuses which will be increased in size.

### Solution to Problem

The technology disclosed herein has been made in view of the above-mentioned problems, and a first aspect thereof is an information processing apparatus including:

a visual effect acquisition unit that acquires information on an element of a visual effect;

an evaluation value calculation unit that calculates an evaluation value of the acquired element of the visual effect with respect to a viewing environment or an image configuration and selects candidates of one or more viewing environments on the basis of an evaluation value; and

a viewing environment presentation unit that presents the viewing environment of the candidate.

In accordance with a second aspect of the technology disclosed herein, the visual effect acquisition unit of the information processing apparatus according to the first aspect is configured to present a menu for selecting the element of the visual effect and acquire information on the element of the visual effect on the basis of a selection operation on the menu.

In accordance with a third aspect of the technology disclosed herein, the viewing environment presentation unit of the information processing apparatus according to the first aspect is configured to display each of the candidates of the viewing environment, which is selected by the evaluation value calculation unit, as a menu item.

In accordance with a fourth aspect of the technology disclosed herein, the viewing environment presentation unit of the information processing apparatus according to the first aspect is configured to display each of the parameters which constitutes the currently selected viewing environment.

In accordance with a fifth aspect of the technology disclosed herein, the viewing environment presentation unit of the information processing apparatus according to the fourth aspect is configured to display at least one of a screen size, a viewing distance, a look-up angle or look-down angle, and a viewing angle from a screen center vertical, as the parameter that constitutes the currently selected viewing environment.

In accordance with a sixth aspect of the technology disclosed herein, the viewing environment presentation unit of the information processing apparatus according to the first aspect is configured to display a viewing position in a viewing space, which corresponds to a currently selected viewing environment.

In accordance with a seventh aspect of the technology disclosed herein, the viewing environment presentation unit of the information processing apparatus according to the fifth aspect is configured to display at least one of the screen size, the viewing distance, and the horizontal angle of view from the viewing position, utilizing a top view of a viewing space.

In accordance with an eighth aspect of the technology disclosed herein, the viewing environment presentation unit of the information processing apparatus according to the fifth aspect is configured to display at least one of the screen size and the look-up angle or look-down angle from the viewing position, utilizing a side view of a viewing space.

In accordance with a ninth aspect of the technology disclosed herein, the viewing environment presentation unit of the information processing apparatus according to the seventh aspect is configured to update each of the parameters which constitutes a currently selected viewing environment, in conjunction with an operation of changing the viewing position.

In accordance with a tenth aspect of the technology disclosed herein, the viewing environment presentation unit of the information processing apparatus according to the first aspect is configured to display an evaluation value of each element of the visual effect with respect to a currently selected viewing environment.

In accordance with a 11th aspect of the technology disclosed herein, the viewing environment presentation unit of the information processing apparatus according to the first aspect is configured to display an evaluation value of each element of the visual effect with respect to the viewing environment that is the candidate, using at least one of a radar chart and a bar.

In accordance with a 12th aspect of the technology disclosed herein, in conjunction with a change in selection of a viewing candidate of the information processing apparatus according to the tenth aspect, the evaluation value calculation unit is configured to re-calculate an evaluation value of a viewing effect with respect to the changed viewing candidate, and the viewing environment presentation unit is configured to update display of the evaluation value of each element of the visual effect on the basis of a result of the re-calculation by the evaluation value calculation unit.

In accordance with a 13th aspect of the technology disclosed herein, in conjunction with an operation of changing the viewing position of the information processing apparatus according to the seventh aspect, the evaluation value calculation unit is configured to re-calculate an evaluation value of a viewing effect with respect to the changed viewing position, and the viewing environment presentation unit is configured to update display of the evaluation value of each element of the visual effect on the basis of a result of the re-calculation by the evaluation value calculation unit.

In accordance with a 14th aspect of the technology disclosed herein, the viewing environment presentation unit of the information processing apparatus according to the first aspect is configured to display, utilizing a seat position in a seat map of a movie theater or another facility, a viewing environment (a screen size, a viewing distance, a look-up angle or look-down angle, and a viewing angle from a screen center vertical as a screen is observed using the seat position as a viewpoint position).

In accordance with a 15th aspect of the technology disclosed herein, the evaluation value calculation unit of the information processing apparatus according to the first aspect is configured to remove a viewing environment whose at least some parameters depart from a recommended range, from the candidate irrespective of superiority or inferiority of the evaluation value of the acquired element.

In accordance with a 16th aspect of the technology disclosed herein, the evaluation value calculation unit of the information processing apparatus according to the first aspect is configured to refer to an evaluation value table describing a relationship between evaluation values of respective elements of the visual effect with respect to each viewing environment and calculate an evaluation value of an element of the visual effect with respect to a viewing environment.

In accordance with a 17th aspect of the technology disclosed herein, the evaluation value calculation unit of the information processing apparatus according to the 16th aspect is configured to refer to the evaluation value table in which influence exerted on each element of the visual effect is quantified as the evaluation value for each parameter of the viewing environment.

In accordance with a 18th aspect of the technology disclosed herein, the evaluation value calculation unit of the information processing apparatus according to the 16th aspect is configured to perform weighting addition on the evaluation value of the element of the visual effect with respect to each parameter of the viewing environment using a weight coefficient for each parameter and calculate a comprehensive evaluation value for each element of the visual effect with respect to the viewing environment.

Further, a 19th aspect of the technology disclosed herein is an information processing method, including:

a visual effect acquisition step of acquiring information on an element of a visual effect;

an evaluation value calculation step of calculating an evaluation value of the acquired element of the visual effect with respect to a viewing environment or an image configuration and selecting candidates of one or more viewing environments on the basis of an evaluation value; and

a viewing environment presentation step of presenting the viewing environment of the candidate.

Further, a 20th aspect of the technology disclosed herein is a computer program described in a computer-readable format that causes a computer to functions as:

a visual effect acquisition unit that acquires information on an element of a visual effect;

an evaluation value calculation unit that calculates an evaluation value of the acquired element of the visual effect with respect to a viewing environment or an image configuration and selects candidates of one or more viewing environments on the basis of an evaluation value; and

a viewing environment presentation unit that presents the viewing environment of the candidate.

The computer program according to the 20th aspect of the technology disclosed herein defines a computer program described in a computer-readable format so as to realize predetermined processing on the computer. In other words, by installing a computer program according to claim 20 of the present application into the computer, a cooperative action is exerted on the computer and actions and effects similar to those of the information processing apparatus according to an aspect of Technology 1 disclosed herein can be obtained.

### Advantageous Effects of Invention

In accordance with the technology disclosed herein, it is possible to provide excellent information processing apparatus, information processing method, and computer program, which can make it easy to select an optimal viewing environment depending on content and preference of each person.

The information processing apparatus according to the technology disclosed herein can make it easy to select an optimal viewing environment depending on content and preference of each person by displaying a relationship between a viewing environment and a visual effect that is set in a display apparatus.

Note that the effects described herein are merely examples and effects of the present invention are not limited thereto. Further, the present invention may provide further additional effects other than the above-mentioned effects.

Still other objects, features, and advantages of the technology disclosed herein will be clear from embodiments to be described later and a more detailed description based on the attached drawings.

### BRIEF DESCRIPTION OF DRAWINGS

FIG. 1 is a view showing a relationship among a screen size, a viewing distance, and an angle of view.

FIG. 2 is a view showing a look-up angle (angle of elevation) of a screen.

FIG. 3 is a view showing a look-down angle (angle of depression) of the screen.

FIG. 4 is a view showing some examples of a viewing angle from a screen center vertical.

FIG. 5 is a view showing an example of an image configuration (image captured by camera at long distance).

FIG. 6 is a view showing an example of an image configuration (close-up image of object).

FIG. 7 is a view showing an example of an image configuration (image with violent motion).

FIG. 8 is a view showing an example of an image configuration (image containing character information).

FIG. 9 is a view illustrating a relationship between a viewing position in a movie theater and a visual effect.

FIG. 10 is a view illustrating a relationship between a viewing position in a movie theater and a visual effect.

FIG. 11 is a view showing a configuration example of a GUI screen for selecting a desired visual effect.

FIG. 12 is a view showing a configuration example of a GUI screen for displaying a viewing environment.

FIG. 13 is a view showing a modified example of a viewing environment display region.

FIG. 14 is a view illustrating evaluation value tables of an element of a visual effect “sense of presence” with respect to each parameter of a viewing environment.

FIG. 15 is a view for describing a method of referring to the evaluation value table of the visual effect with respect to the viewing environment.

FIG. 16 is a view showing how a combination of an evaluation value table of the visual effect with respect to each parameter of the viewing environment and a degree-of-influence coefficient is managed for each element of the visual effect.

FIG. 17 is a view illustrating expressions for calculating a comprehensive evaluation value of each viewing environment.

FIG. 18 is a view showing a table indicating an evaluation value of each element of the visual effect with respect to each viewing environment.

FIG. 19 is a view showing a configuration example of an evaluation value table of the visual effect “sense of presence” with respect to a viewing environment combining an angle of view with an angle of elevation/angle of depression.

FIG. 20 is a view illustrating a table describing a correspondence relationship between a seat number and each parameter of the viewing environment in the case of expressing the viewing environment utilizing the seat map.

FIG. 21 is a view showing a table indicating an evaluation value for each element of the visual effect with respect to a seat number.

FIG. 22 is a view schematically showing a system configuration example in which an evaluation value table of the visual effect with respect to the viewing environment is set for each genre of content.

FIG. 23 is a diagram for describing a mechanism for learning results obtained by an observer performing a fine control operation on the viewing environment.

FIG. 24 is a view showing a system configuration example of an information processing apparatus 2400 that realizes processing of supporting selection of an optimal viewing environment.

FIG. 25 is a view schematically showing functional configurations for realizing the processing of supporting selection of an optimal viewing environment.

FIG. 26 is a flowchart showing a processing procedure for supporting content-observer's selection of an optimal viewing environment.

FIG. 27 is a flowchart showing another example of the processing procedure for supporting content-observer's selection of an optimal viewing environment.

### MODE(S) FOR CARRYING OUT THE INVENTION

Hereinafter, embodiments of the technology disclosed herein will be described in detail with reference to the drawings.

### A. Selection Support of Viewing Environment

How an image is seen is defined by parameters such as a screen size, a viewing distance, a look-up angle or look-down angle, and a viewing angle from a screen center vertical, roughly. As a screen is considered in a plane, the screen size and the viewing distance can be expressed as an angle of view. Further, a display method of combining a background image outside an original image is as described above. Herein, the parameters indicating how an image is seen, such as the angle of view, the look-up angle or look-down angle, and the viewing angle from the screen center vertical as well as the background part outside the image are defined as “viewing environments”.

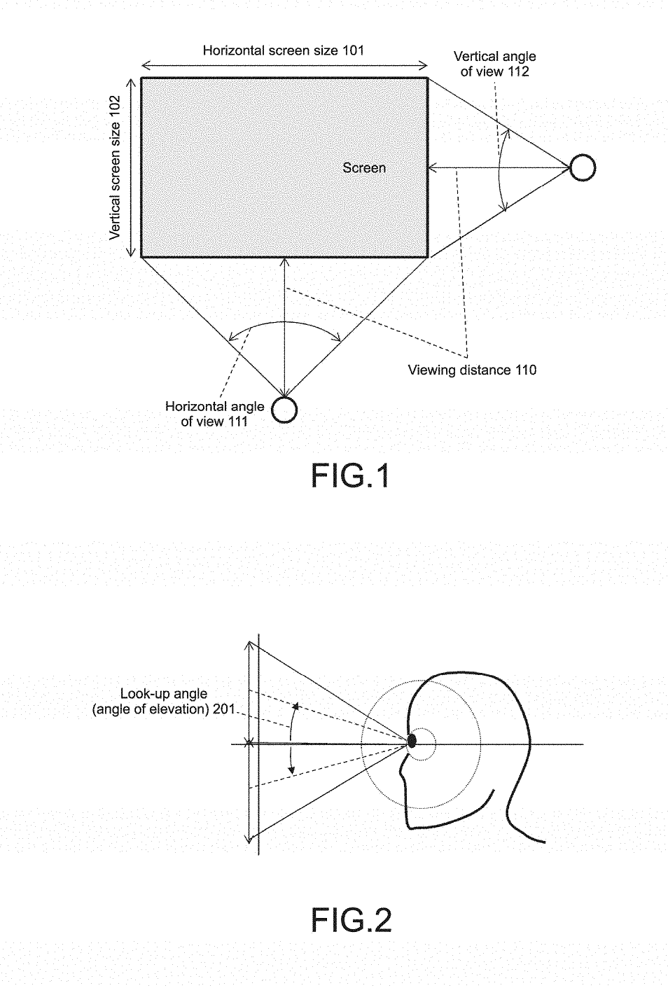

FIG. 1 shows a relationship among the screen size, the viewing distance, and the angle of view. The size of the screen depends on a horizontal screen size 101 and a vertical screen size 102. Then, the size of the image seen from an observer is generally evaluated as a horizontal angle of view 111 and a vertical angle of view 112 on the basis of the horizontal and vertical screen sizes 101 and 102 and a viewing distance 110.

For those parameters 111 and 112 regarding the angles of view, optimal values are not uniquely defined. Their suitable states vary in a manner that depends on characteristics of content and preference of each person who observe the content (i.e., visual effect desired by each person). For example, with a larger angle of view, it is easier to feel impact and a sense of presence from video while perspicuity is lowered. In general, it is considered that the larger angle of view is suitable for content in a genre that requires the impact and the sense of presence (action movie, race game, etc.). However, it still depends on preference of each person. On the other hand, a smaller angle of view may be more suitable for visibility of a subtitle of a movie, status information of a game, or the like. With character information such as a subtitle, it can be addressed by controlling a display position (not the viewing environment such as the angle of view). However, the smaller angle of view is still necessary in a manner that depends on an image region whose contents should be grasped on the basis of the composition of the content.

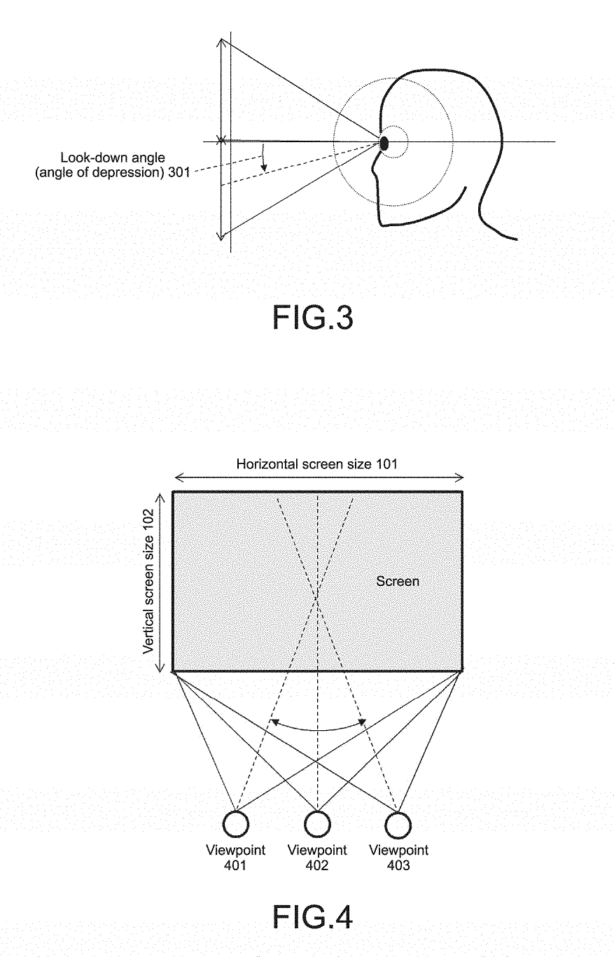

Further, FIGS. 2 and 3 respectively show a look-up angle (angle of elevation) 201 and a look-down angle (angle of depression) 301 of a screen. The look-up angle 201 and the look-down angle 301 are determined by an amount of offset between a height of an observer's eye and a vertical position of a screen.

It is known that impression given to a person by an observation image is changed in a manner that depends on a difference between the look-up angle 201 and the look-down angle 301. For example, it is easy to obtain the impact in a direction of the look-up angle and it is easy to obtain the sense of presence in a direction of the look-down angle.

Further, it is considered that the direction of the look-down angle is favorable in view of the fact that eyes get easily fatigued. It is because as the look-up angle becomes larger, an eyeball exposure area becomes larger and it becomes easier for moisture of eyeball surface to evaporate. Also in VDT (Visual Display Terminals) work, the look-down direction (angle of depression of about 10 degrees) is recommended.

Further, FIG. 4 shows some examples of the viewing angle from the screen center vertical. It can be said that a viewpoint position 402 at which the viewing angle is closer to 0 degrees is a viewing environment favorable for viewing because observers can directly face the screen. However, for example, because of dominant eyes or eyesight differences of individual observers, a viewpoint position 401 deviated to the left from 0 degrees or a viewpoint position 403 deviated to the right conversely may be more favorable.

Regarding visual performance of human eyes, it is known that they have non-uniform characteristics in a manner that depends on regions, for example, an effective field of view where a line of sight can be quickly moved, a stable fixation visual field where information can be easily acquired with head motion, and an induction visual field where a coordinate-system induction effect due to visual information is produced, which induces a sense of presence, about a discrimination visual field excellent in eyesight (e.g., see Patent Literature 5) and have anisotropy in each of left, right, upper, and lower directions.

It is also conceivable that the fact that a visual effect (how an image is seen, for example, impression given by the image or strong and weak points) differs in a manner that depends on changes in viewing environments such as an angle of view, a look-up angle or look-down angle, and a viewing angle from a screen center vertical as described above greatly depends on such visual performance of human eyes. Therefore, it can be said that, in order for an image observer to obtain a desired visual effect, it is desirable to define a selection method for a viewing environment on the basis of the human visual performance.

In addition, in order to obtain a desired visual effect, the inventors consider that not only a viewing environment, but also an internal configuration of an image have to be considered. Herein, the internal configuration of the image is defined as an “image configuration”.

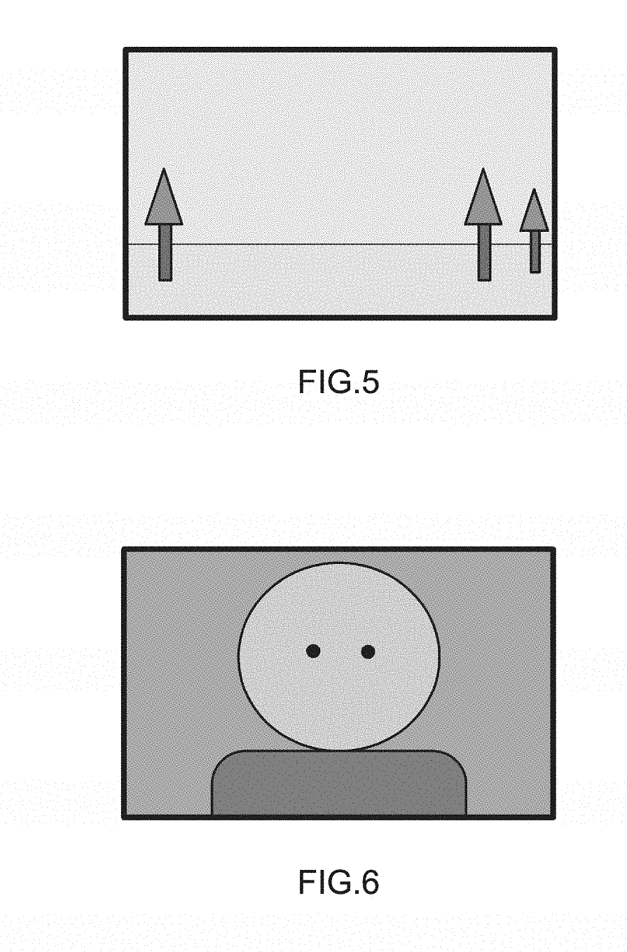

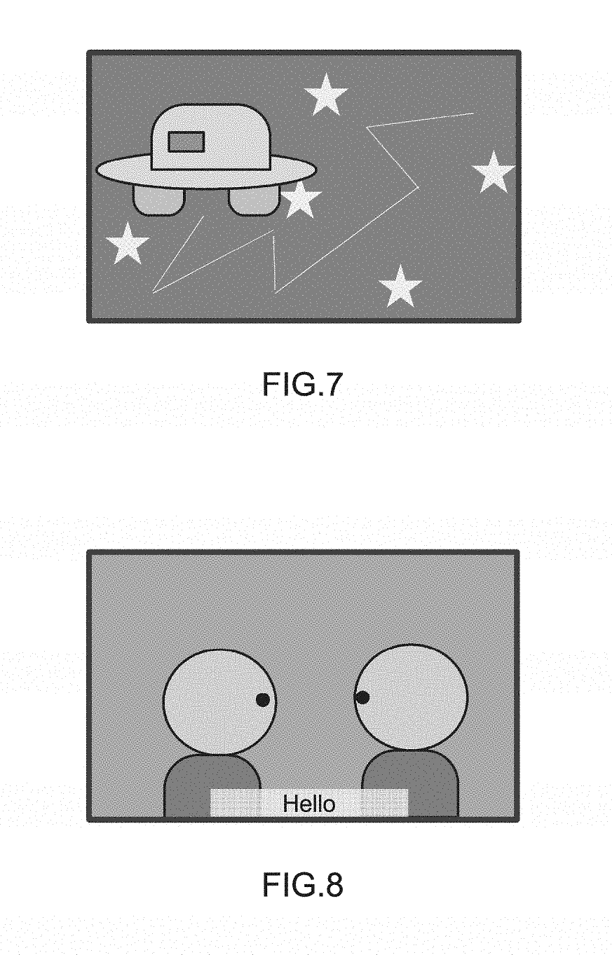

FIGS. 5 to 8 show configuration examples of various images. FIG. 5 is an image captured by a camera at a long distance (zoom out). FIG. 6 is a close-up image of an object such as the face of a person. FIG. 7 is an image with a violent motion, such as a captured image of a moving object. FIG. 8 is an image containing character information such as a subtitle. In this manner, there are various image configurations, for example, a composition, violence of motion, and a presentation position of character information such as a subtitle. The image configurations are roughly classified in a manner that depends on content genres (movie, sports, news, etc.). In addition, the image configurations can be finely classified for each content.

Even in the case where the above-mentioned viewing environment is the same, how an image is seen is changed if the image configuration is different. Therefore, it can be said that, in order for an image observer to obtain a desired visual effect, it is more desirable to define the selection method for the viewing environment, also considering a configuration of an image that is an observation target.

In a facility specialized for viewing such as a movie theater, an audience member can select a desired viewing environment freely in some extent and observe an image by selecting a seat depending on preference of each audience member, that is, a viewing position.

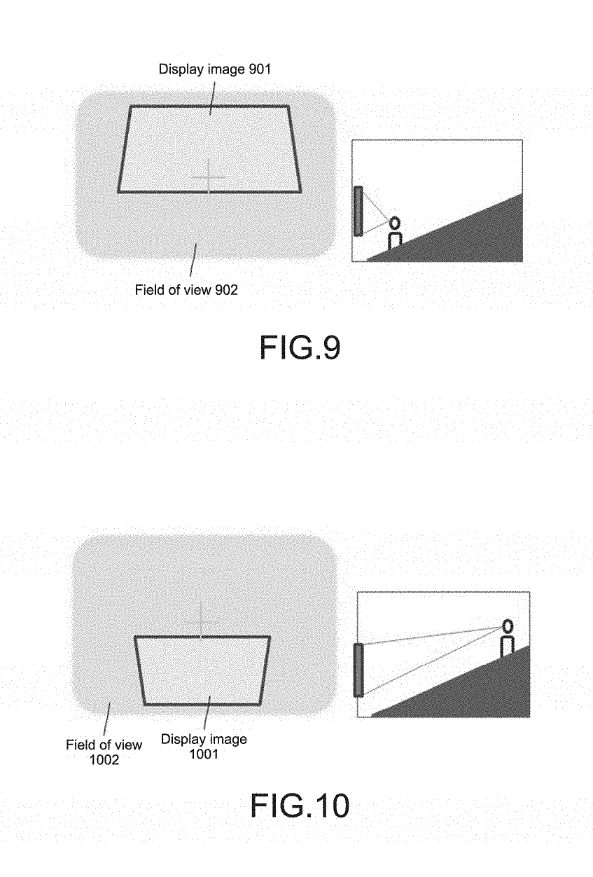

FIGS. 9 and 10 each illustrate a relationship between a viewing position and a visual effect in a movie theater.

In the example shown in FIG. 9, there is a viewing environment where an observer sits in a front, lower seat and looks up a large screen. In this case, a display image 901 has an isosceles trapezoid shape having a shorter upper base within a field of view 902 of the observer. Thus, the impact can be obtained as the visual effect.

On the other hand, in the example shown in FIG. 10, it is a viewing environment where an observer sits in a rear, higher seat and looks slightly up the screen at such an angle of view that the screen appropriately falls within the field of view. In this case, a display image 1001 has an isosceles trapezoid shape having a shorter lower base conversely within a field of view 1002 of the observer. Thus, the perspicuity is enhanced and a visual effect of enjoying overlooking the entire image can be obtained.

In the case of a display device having a small screen, there are not many options of the viewing environments. In contrast, in the case of a large-screen display device, parameters such as an angle of view, a look-up angle or look-down angle, and a viewing angle from a screen center vertical can be changed and the options of the viewing environments increase.

Further, a head-mounted display has a configuration in which a virtual-image optical system constituted of a plurality of optical lenses is disposed in front of a display panel, for example, so as to form an enlarged virtual image of a display image on the retina of the eye of an observer. It is easy to configure a free viewing environment. For example, it is possible to control the viewing environment in a direction that decreases the angle of view within a range of a maximum angle of visibility determined on the basis of the size of the display panel and optical design. Further, it is possible to adjust the look-up angle or look-down angle, using a display position in the upper and lower directions. That is, more and more display devices have a function of controlling the viewing environment.

The visual effect includes various elements such as impact, a sense of presence, perspicuity, fatigue resistance, and realistic feeling. Further, the viewing environment is constituted of a plurality of parameters such as an angle of view, a look-up angle or look-down angle, and a viewing angle from a screen center vertical. It is not easy for general users who are not professionals to understand which visual effect each parameter of the viewing environment influences. In addition, a configuration of an image that is an observation target also influences the visual effect. Further, each element of the visual effect with respect to the viewing environment and the image configuration changes, having a mutual relationship. Therefore, it is difficult for general users who are not professionals to determine which viewing environment should be selected in order to obtain a desired visual effect.

In view of this, in the technology disclosed herein, there is proposed a system of automatizing selection of the viewing environment suitable for image viewing or supporting observer's selection of the viewing environment.

A visual effect that should be considered as important differs for each content genre or on a content-by-content basis. Further, there is also a visual effect more desirable for an observer who views an image. In the technology disclosed herein, an evaluation value of each element of the visual effect with respect to the viewing environment and the image configuration is determined in advance. Then, when an observer tries to start image viewing, for example, candidates of the viewing environment that having a higher evaluation value of a specified element of the visual effect are automatically extracted and presented. In this manner, selection of the viewing environment by an observer who does not know much about the visual effect is supported. The “evaluation value” of the viewing environment as set forth herein is numerical-value data introduced for quantatively expressing influence exerted on each element of the visual effect by the viewing environment. Details of the evaluation value of the visual effect will be described later. In addition, in the technology disclosed herein, when presenting candidates of the viewing environment, parameters of the viewing environment that are the candidates are displayed as GUI (Graphical User Interface) or influence exerted on each element of the visual effect by that candidate are displayed as GUI. In this manner, it becomes possible for an observer to understand the influence of the visual effect and select a viewing environment.

Any method can be used for determining an evaluation value of each element of the visual effect with respect to the viewing environment and the image configuration. The visual effect with respect to the viewing environment and the image configuration has already been studied by some organizations. Further, numerous reports regarding evaluation values of the sense of presence with respect to the angle of view, recommended ranges for the angle of view and the look-up angle or look-down angle in a music hall, a theater, a movie theater, etc., and the like have already been made. The evaluation value of each element of the visual effect with respect to the viewing environment and the image configuration may be determined by basically being based on results of studies published by those organizations and additionally verifying them if necessary.

Each element of the visual effect with respect to the viewing environment and the image configuration changes, having a mutual relationship. For example, as the angle of view becomes larger, the impact is enhanced while the fatigue resistance is lowered. General users hardly have knowledge about those viewing environment and visual effect. In addition, the relationship between the viewing environment and the visual effect changes on a content-by-content basis or for each content genre. Thus, it is difficult to select an optimal viewing environment.

In the technology disclosed herein, on the basis of the evaluation value determined in advance with respect to the viewing environment and the image configuration, a viewing environment that is most likely to provide a desired visual effect is automatically selected and each parameter of that viewing environment is displayed as GUI in an easily understandable manner. Further, an evaluation value of each element of the visual effect in the selected viewing environment is displayed as a numerical value. In addition, a radar chart and a bar are also used. Thus, perspicuity is enhanced and a correlation relationship is displayed in a manner easy to intuitively understand.

Further, that whose evaluation value with respect to an element of a desired visual effect exceeds a certain value is considered as a selection candidate. If a plurality of candidates are present, they are listed and displayed.

Note that, when selecting a viewing environment that is most likely to provide a desired visual effect, a viewing environment departing from a recommended range in view of health damage such as fatigue of eyes is favorably removed from the selection candidates irrespective of whether or not the evaluation value of the visual effect is good.

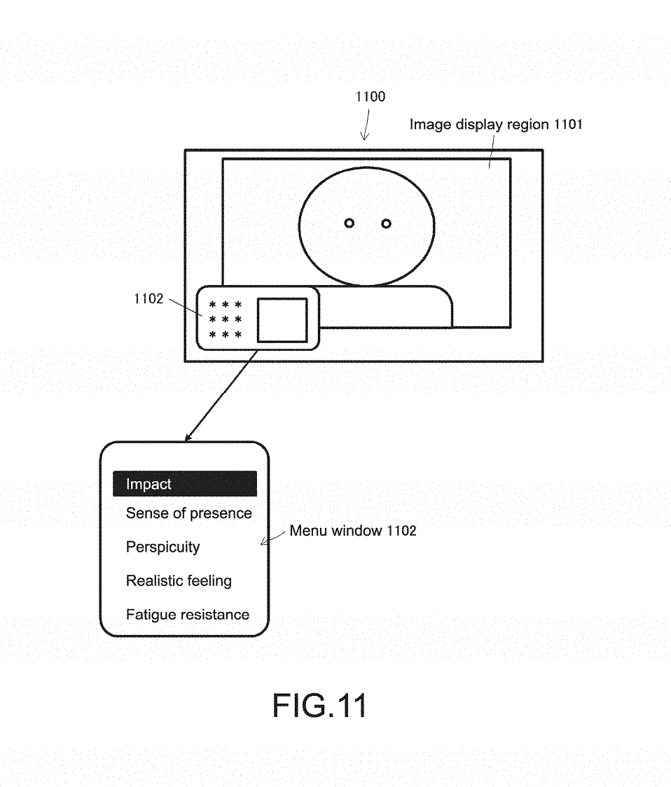

FIG. 11 shows a configuration example of a GUI screen for selecting a desired visual effect. In the example shown in the figure, a screen 1100 includes a region 1101 in which an original image that is a target for selecting a viewing environment is displayed, which occupies a large part of the entire screen 1100, and a menu window 1102 that appears a lower left part of the screen 1100. In the lower part of FIG. 11, the menu window 1102 is shown in an enlarged state. Within the menu window 1102, respective elements of the visual effect “impact”, “sense of presence”, “perspicuity”, “realistic feeling”, and “fatigue resistance” are displayed in a list as menu items (options). An image observer can select in the menu window 1102 an element of the visual effect that is desired (or considered as important) by the image observer. Concurrent selection of two or more elements may be allowed. In the example shown in the figure, “impact” reversely displayed is currently selected.

Note that, as shown in FIG. 11, instead of an observer selecting a desired element of the visual effect through a manual operation, a suitable visual effect may be automatically selected by the system on the basis of the image configuration, the content genre, and the like (irrespective of observer's intention). Alternatively, the observer's intention and the image configuration, the content genre, and the like may be comprehensively evaluated by the system and a suitable visual effect may be selected.

Further, a content creator may be allowed to specify an element of the visual effect that is important in viewing content created by the content creator. The element of the visual effect that is specified by the content creator may be, for example, described in metadata associated with a moving-image stream of MPEG (Moving Picture Experts Group) or the like or may be described in a database file in a Blu-ray disc that stores a moving-image file. At the system, when selecting a viewing environment, an effect of the visual effect that is important in selecting the viewing environment is selected also referring to the contents specified by the content creator.

When the selection of the visual effect is determined by any method, a viewing environment that is most likely to provide a desired visual effect is automatically selected on the basis of the evaluation value determined in advance with respect to the viewing environment and the image configuration. It should be noted that, when selecting a viewing environment that is most likely to provide a desired visual effect, a viewing environment departing from a recommended range in view of health damage such as fatigue of eyes is favorably removed from the selection candidates irrespective of whether or not the evaluation value of the visual effect is good.

Then, when the automatic selection of a viewing environment that is most likely to provide a desired visual effect ends at the system, this viewing environment is displayed on the GUI screen in an easily understandable manner. Further, that whose evaluation value with respect to an element of a desired visual effect exceeds a certain value is considered as a selection candidate. If a plurality of candidates are present, viewing environments that are the candidates are listed and displayed on the GUI screen.

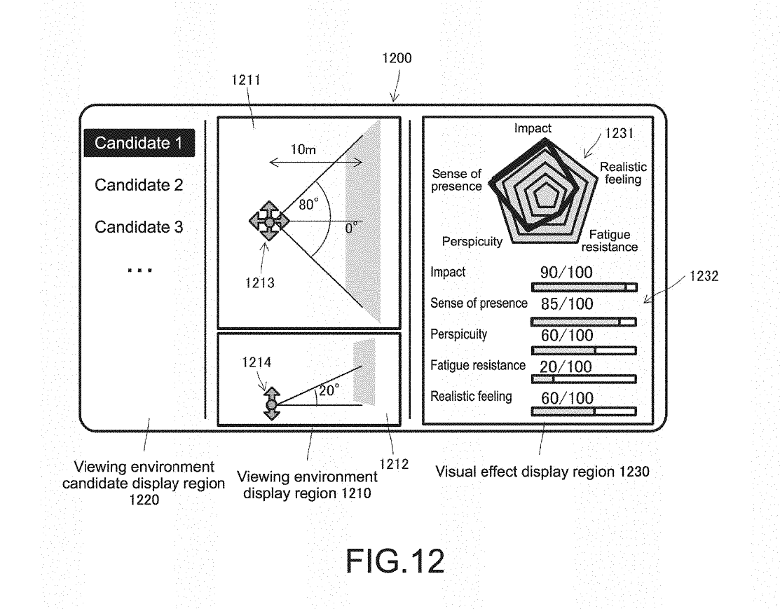

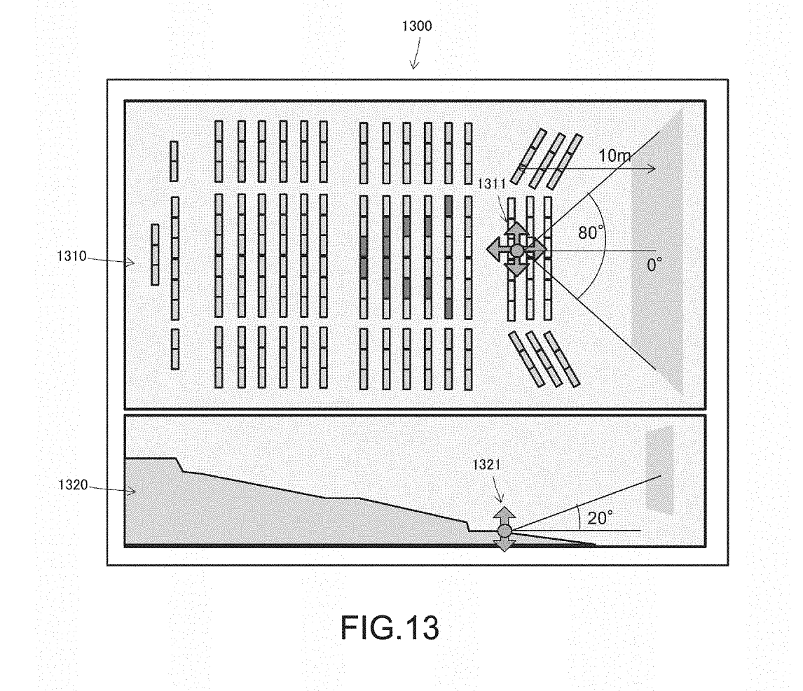

FIG. 12 shows a configuration example of a GUI screen 1200 that displays a viewing environment. The GUI screen 1200 that displays the viewing environment shown in the figure is constituted of a viewing environment display region 1210 at the center of the screen, a viewing environment candidate display region 1220 on the left side of the screen, and a visual effect display region 1230 on the right side of the screen.

The viewing environment candidate display region 1220 displays a list of candidates of the viewing environment in which an observer can obtain a desired visual effect. As described above, in the case where a plurality of viewing environments whose evaluation value with respect to an element of a desired visual effect exceeds a certain value have been found, they are displayed as candidates in the viewing environment candidate display region 1220. Candidates “Candidate 1”, “Candidate 2”, and “Candidate 3”, . . . displayed in the viewing environment candidate display region 1220 are menu items (options) that an observer can select.

The viewing environment display region 1210 displays a viewing position in a viewing space that corresponds to a currently selected viewing environment in the viewing environment candidate display region 1220, together with respective parameters that constitute the viewing environment. In the example shown in FIG. 12, “Candidate 1” reversely displayed in the viewing environment candidate display region 1220 is currently selected. In the viewing environment display region 1210, the respective parameters that constitute the viewing environment of “Candidate 1” are displayed.

As described above, the viewing environment is defined by parameters such as a screen size, a viewing distance, a look-up angle or look-down angle, and a viewing angle from a screen center vertical, roughly. In the example shown in FIG. 12, a screen size, a viewing distance (in example shown in figure, 10 meters), and a horizontal angle of view (in example shown in figure, 80 degrees) are displayed in a display region 1211 of an upper half of the viewing environment display region 1210, utilizing a top view of the viewing space. Further, a screen size and a look-up angle or look-down angle (in example shown in figure, look-up angle of 20 degrees) are displayed in the display region 1212 of a lower half of the viewing environment display region 1210, utilizing a side view of the viewing space. Note that, although not shown in the figure, a vertical angle of view may be further displayed in the display region 1212 of the lower half of the viewing environment display region 1210.

Display of the viewing environment display region 1210 is, in real-time, in conjunction with the selection of the viewing environment in the viewing environment candidate display region 1220. In the example shown in FIG. 12, a parameter of the viewing environment of “Candidate 1” currently selected is displayed in the viewing environment display region 1210. When another candidate is re-selected in the viewing environment candidate display region 1220, the viewing environment display region 1210 is transitioned to display of a parameter of the viewing environment that is the corresponding candidate.

As shown in FIG. 12, the viewing environment display region 1210 displays each parameter of the viewing environment in a projective figure as the viewing space is viewed from the top and the side. Therefore, in comparison with the case of simply displaying a numerical value of each parameter of the viewing environment, it becomes easy for an observer to intuitively understand the viewing environment.

The current viewing positions are denoted by the reference numbers 1213 and 1214 within the viewing environment display region 1210. The viewing positions 1213 and 1214 are cursors. By operating the cursors, an observer can further arbitrarily adjust the viewing position. In the display region 1211 of the upper half of the viewing environment display region 1210, the cursor indicating the viewing position 1213 is moved in the upper and lower, left and right directions of the screen and the viewing position is changed in a horizontal direction within the viewing space. In this manner, parameters of the viewing environment such as a viewing distance and an angle of view can be arbitrarily adjusted. Further, in the display region 1212 of the lower half of the viewing environment display region 1210, an observer moves a cursor indicating a viewing position 1214 in the upper and lower directions of the screen and changes the viewing position in the upper and lower directions within the viewing space. In this manner, the look-up angle or look-down angle can be arbitrarily adjusted. Alternatively, instead of the indirect operations of moving the viewing positions 1213 and 1214, the viewing environment may be directly changed by performing an operation of correcting the numerical value of the parameter of the viewing environment displayed in the viewing environment display region 1210 (e.g., overwriting the display of the viewing distance from 10 meters to 8 meters in the display region 1211 or overwriting the look-up angle of 20 degrees by 15 degrees in the display region 1212). For correction of the parameter of the viewing environment, keyboard input and voice input, for example, can be utilized. The display of the viewing environment display region 1210 is, in real-time, in conjunction with the selection or change operation of the viewing environment as described above.

The visual effect display region 1230 displays evaluation values of respective elements of the visual effect in the viewing environment currently specified in the viewing environment display region 1210. In the example shown in the figure, regarding the viewing environment of Candidate 1, high evaluation values are obtained in terms of elements of the visual effect such as impact and a sense of presence while only low evaluation values are obtained in terms of elements of fatigue resistance and realistic feeling. In the example shown in FIG. 12, the evaluation values of the respective elements of the visual effect in the selected viewing environment are not simply displayed as numerical values but are displayed using a radar chart 1231 and bars 1232. Therefore, the perspicuity is enhanced. It thus becomes easy to intuitively understand a correlation relationship between the viewing environment and the visual effect or a correlation relationship between the respective elements of the visual effect. Therefore, it is considered that it is a sufficient support for an image observer in selecting the viewing environment.

The display of the visual effect display region 1230 is, in real-time, in conjunction with the selection of the viewing environment in the viewing environment candidate display region 1220 and the change operation of the viewing environment within the viewing environment display region 1210. In the example shown in FIG. 12, the evaluation values regarding the respective elements of the visual effect with respect to the viewing environment of “Candidate 1” currently selected are displayed in in the visual effect display region 1230. When another candidate is re-selected in the viewing environment candidate display region 1220, the visual effect display region 1230 transitions to display of the evaluation values regarding the respective elements of the visual effect with respect to the viewing environment of the corresponding candidate. Further, when the operation of changing the viewing position is performed in the viewing environment display region 1210, it transitions to the display of the evaluation values regarding the respective elements of the visual effect with respect to the viewing environment of the viewing position after the change.

Note that, although the viewing space is expressed using the projective figure in the viewing environment display region 1210 in the example shown in FIG. 12, the viewing space may be stereoscopically expressed like a sketch.

FIG. 13 shows a modified example of the viewing environment display region in the GUI screen shown in FIG. 12. In a viewing environment display region 1300 shown in the figure, a viewing environment is expressed utilizing a seat map of a movie theater (or a facility such as a music hall and a theater).

Each of seat on the seat map correspond to a viewing environment. The viewing environments are parameters such as a screen size, a viewing distance, a look-up angle or look-down angle, and a viewing angle from a screen center vertical (as described above). The seat position uniquely defines a combination of those parameters as the screen is observed using it as a viewpoint position.

Within the viewing environment display region 1300 utilizing the seat map, the selected viewing environment is displayed as a seat position in the movie theater. In the example shown in FIG. 13, the viewing distance (in example shown in figure, 10 meters) from a selected seat position 1311 to the screen and the horizontal angle of view (in example shown in figure, 80 degrees) are displayed on the seat map of the movie theater, using a display region 1310 of an upper half of the viewing environment display region 1300. Further, the look-up angle or look-down angle (in example shown in figure, look-up angle of 20 degrees) as the screen is viewed from a selected seat position 1321 in a seat side view of the movie theater is displayed using the display region 1320 of a lower half of the viewing environment display region 1300. Note that, although not shown in the figure, the vertical angle of view may be further displayed in the display region 1320.

Although omitted from FIG. 13, it is assumed that one or more seats in which an observer can obtain a desired visual effect are displayed as a list of candidates in the viewing environment candidate display region. The seat positions 1311 and 1321 displayed and selected in the viewing environment display region 1300 are seat positions corresponding to the currently selected viewing environment from the candidates displayed in the viewing environment candidate display region (as described above). Therefore, an observer can select a viewing environment in a sense similar to that of specifying a seat in the viewing environment candidate display region.

Further, the seats are displayed in the viewing environment display region 1300 while the seats are colored correspondingly to evaluation values of an element of the visual effect that is desired by an observer. Therefore, an observer can see the seat map in the viewing environment display region 1300 and intuitively understand an optimal seat. In the example shown in FIG. 13, a seat having a higher evaluation value with respect to an element of the visual effect that is desired by an observer is displayed in darker color and a seat having a lower evaluation value is displayed in lighter color. Rather than selecting one of the candidates of the viewing environment listed up in the viewing environment candidate display region (not shown), a viewing environment may be selected in a visually easily understandable manner by an operation of directly specifying a seat in the viewing environment display region 1300.

In accordance with the viewing environment display region 1300 utilizing the seat map of the movie theater as shown in FIG. 13, it becomes further easy for an observer to understand selection of the viewing environment. Further, the seat positions 1311 and 1321 are cursors. An observer can change the viewing environment by operating the cursors to move the seat positions. The viewing distance and the angle of view can be arbitrarily adjusted on a seat-by-seat basis by moving the cursor indicating the selected seat position 1311 in the upper and lower, left and right directions and changing the seat position on the seat map displayed in the display region 1310 of the upper half of the viewing environment display region 1300. As a matter of course, the viewing environment may be directly changed by performing an operation of correcting the numerical value of the parameter of the viewing environment displayed in the viewing environment display region 1300 (e.g., overwriting the display of the viewing distance from 10 meters to 8 meters on the screen). For correction of the parameter of the viewing environment, for example, keyboard input and voice input can be utilized. When the parameter value is corrected, the cursors 1311 and 1321 are moved to the corresponding seat positions. Further, although not shown in the figure, in the visual effect display region, the display is successively changed to the evaluation values regarding the respective elements of the visual effect with respect to the viewing environment corresponding to the seat in conjunction with the selection or the change operation of the seat position in real-time.

An observer can understand influence on a desired visual effect through the GUI screens shown in FIGS. 12 and 13 and suitably perform operations of selecting and finely controlling the viewing environment.

The reason why the fine control operation of the viewing environment is enabled to be performed in the viewing environment display region on the GUI screens shown in FIGS. 12 and 13 is that there are differences between individuals in the human visual performance and differences between individuals that are caused in the evaluation value of the visual effect with respect to the viewing environment should be compensated for. Further, preference of individuals should also be considered in evaluation of the visual effect with respect to the viewing environment and the image configuration. Differences between mechanically calculated evaluation values and the preference of individuals can be overcome by the fine control.

In the GUI screen shown in FIG. 11, an observer can select an element of the visual effect that is desired (or considered as important by the observer) utilizing the menu window 1102 (as described above). Further, in accordance with the GUI screen shown in FIG. 12 (and FIG. 13), an optimal viewing environment in which a desired visual effect can be obtained is displayed in the viewing space. The evaluation values of the respective elements of the visual effect with respect to the viewing environment are displayed in conjunction with selection of the viewing environment.

Therefore, rather than simply selecting a desired visual effect, an observer can select and control an optimal viewing environment while successively checking the correlation relationship between the viewing environment and the visual effect or the correlation relationship between the respective elements of the visual effect. Further, an observer can check the relative relationship of the visual effect. Therefore, an observer can select an intended viewing environment while balancing between the respective elements of the visual effect.

Further, in selection of the viewing environment, a safety measure is performed on the viewing environment that can cause health damage such as fatigue of eyes (i.e., viewing environment having at least some parameters departing from a recommended range). As the safety measure, that viewing environment is removed from the candidates in advance such that the viewing environment cannot be selected or the viewing position is prevented from entering that viewing environment such that the viewing environment cannot be controlled, for example. Alternatively, as another safety measure, warning indicating that the viewing environment that can cause health damage is selected may be displayed. Additionally, it is favorable to display the GUI display regions as shown in FIGS. 11 to 13 at positions easy for an observer to see on the screen, in view of the visual performance.

### B. Visual-Effect Evaluation Method

As described above, the technology disclosed herein supports selection of an optimal viewing environment in which an observer can obtain a desired visual effect at a display device such as a head-mounted display and a large-screen display. Further, the numerical-value data called evaluation value is introduced in order to quantitatively express the influence exerted on the visual effect by the viewing environment. Here, a calculation method for the evaluation value of the visual effect with respect to the viewing environment will be described.

The visual effect includes a plurality of elements such as “impact”, “sense of presence”, “perspicuity”, “realistic feeling”, and “fatigue resistance”. On the other hand, the viewing environment is defined by parameters such as the screen size, the viewing distance, the look-up angle or look-down angle, and the viewing angle from the screen center vertical, and further the background part outside the image. A degree of influence exerted by each element of the visual effect from each parameter of the viewing environment is not even but different. Further, the influence exerted on the visual effect by each parameter of the viewing environment is not even but different for each element.

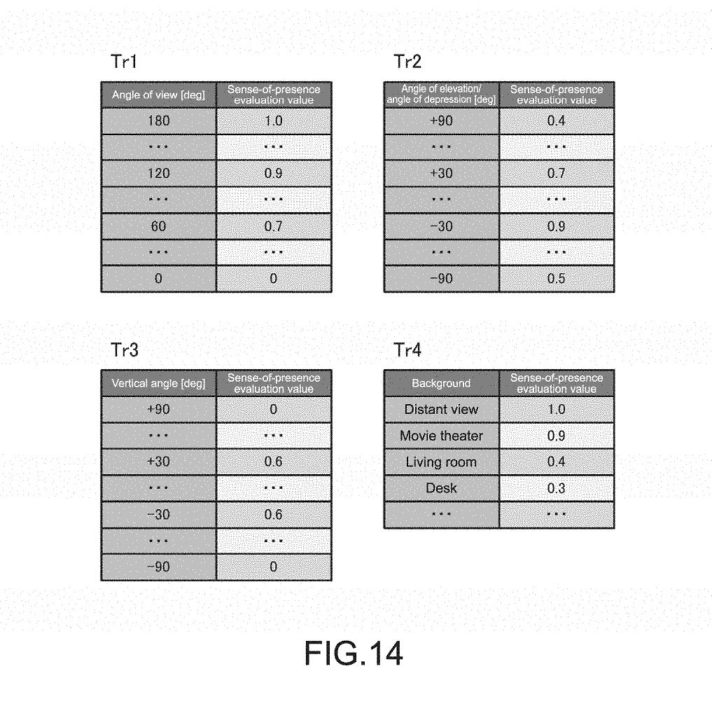

Therefore, regarding the evaluation value of the visual effect with respect to the viewing environment, it is necessary to quantify the influence exerted on each element of the visual effect as the evaluation value for each parameter of the viewing environment in advance. For example, regarding “sense of presence” that is one of the elements of the visual effect, an evaluation value of each parameter of the viewing environment (angle of view, look-up angle/look-down angle, vertical angle, and background) is different. Therefore, as shown in FIG. 14, evaluation value tables Tr1, Tr2, Tr3, and Tr4 of the element of the visual effect “presence (r)” are necessary for each parameter of the viewing environment (angle of view, angle of elevation/angle of depression, vertical angle, and background). Note that, in the example shown in the figure, the evaluation values of each of the tables Tr1 to Tr4 are normalized. Although not shown in the figures, also regarding other elements of the visual effect “impact”, “perspicuity”, “realistic feeling”, and “fatigue resistance”, evaluation value tables of the viewing environment for each parameter of the viewing environment are also necessary.

Further, a degree of influence given to the visual effect by each parameter of the viewing environment differs for each element of the visual effect. In view of this, a coefficient (weight coefficient) indicating a degree of influence exerted by each parameter of the viewing environment is defined for each element of the visual effect. In Table 1 below, coefficients αr1 to αr4 each indicating the degree of influence given to the element of the visual effect “sense of presence” by each parameter of the viewing environment (angle of view, look-up angle/look-down angle, vertical angle, and background) are shown. It should be noted that the coefficients αr1 to αr4 have been normalized (i.e., αr1+αr2+αr3+αr4=1)

A comprehensive evaluation value Er of the visual effect “sense of presence” with respect to the viewing environment can be calculated by referring to the evaluation values in the viewing environment tables Tr1, Tr2, Tr3, and Tr4 of the elements of the visual effect with respect to each parameter and performing weighting addition using the coefficients αr1 to αr4 of each parameter of the viewing environment as shown in Expression (1) below.

[Expression 1]

Er=αr1×Tr1(Angle of view)+αr2×Tr2(Angle of elevation/angle of depression)+αr3×Tr3(Vertical angle)+αr4×Tr4(Background) (1)

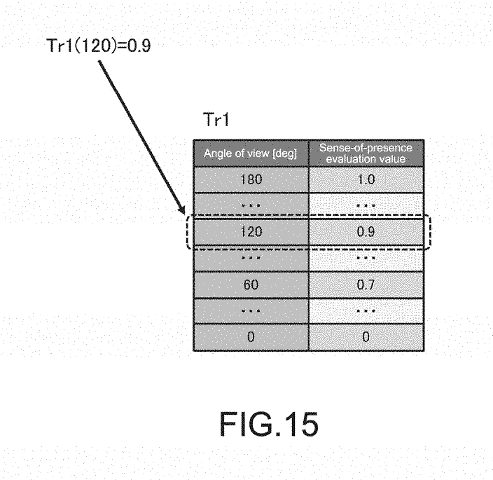

It should be noted that, in Expression (1) above, Trn (X) means an evaluation value of the visual effect “sense of presence” corresponding to a parameter value X in an evaluation value table Trn of an nth viewing environment parameter. For example, as shown in FIG. 15, an evaluation value Tr1 (120) of the visual effect corresponding to the angle of view of 120 degrees of a first viewing environment parameter “the angle of view” in the evaluation value table Tr1 is 0.9.

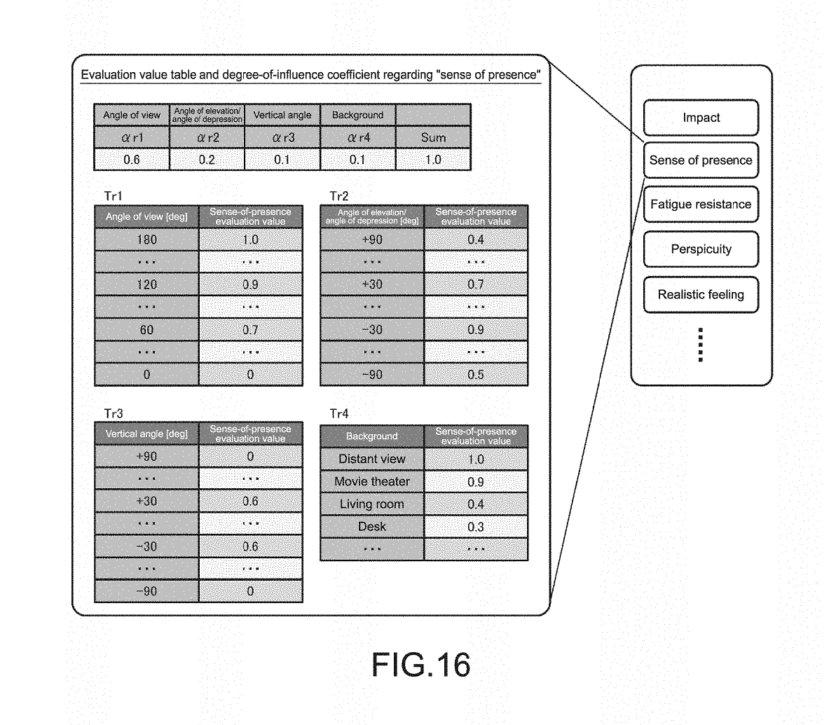

Therefore, it is necessary to set, in advance, the coefficient indicating the degree of influence of each parameter of the viewing environment (angle of view, look-up angle/look-down angle, vertical angle, and background). Then, as shown in FIG. 16, in the evaluation value tables (Tr1, Tr2, Tr3, and Tr4) for each element of the visual effect with respect to each parameter of the viewing environment, it is good to combine and manage the coefficient (αr1, αr2, αr3, and αr4) indicating the degree of influence exerted by each parameter of the viewing environment (angle of view, look-up angle/look-down angle, vertical angle, and background).

Further, hereinabove, the evaluation value table and the calculation method for the comprehensive evaluation value of the viewing environment corresponding to it have been described exemplifying the element “sense of presence” that is one of the visual effects. Also regarding other elements of the visual effect “fatigue resistance”, “impact”, “realistic feeling”, “perspicuity”, . . . , it is necessary to set evaluation value tables for each element of the visual effect with respect to each parameter of the viewing environment and a combination of coefficients indicating degrees of influence exerted by respective parameters of the viewing environment (angle of view, look-up angle/look-down angle, vertical angle, and background) in advance.

The combination of the evaluation value tables for each element of the visual effect with respect to each parameter of the viewing environment and the degree-of-influence coefficients are managed as a database, for example. When selecting the viewing environment of certain image content, a desired element of the visual effect is specified. Then, the evaluation value table and the degree-of-influence coefficient regarding that element of the visual effect are retrieved from the database. The comprehensive evaluation value regarding each viewing environment is calculated in accordance with a calculation expression similar to Expression (1) above. Then, calculation results are summed and the viewing environment having a high evaluation value is picked up as the candidate (option) and presented to an observer.

For example, “sense of presence” is selected by an observer as a desired visual effect via the menu window 1102 of the GUI screen shown in FIG. 11. Then, referring to the evaluation value tables Tr1, Tr2, Tr3, and Tr4 regarding “sense of presence” of each parameter of the viewing environment, the comprehensive evaluation value Er for “sense of presence” is calculated using Expression (1) above, regarding the viewing environment constituted of a combination of the respective parameters (angle of view, look-up angle/look-down angle, vertical angle, and background). Then, they are displayed as a list of the candidates (options) of the viewing environment in the sequential order having a higher comprehensive evaluation value Er in, for example, the viewing environment candidate display region 1220 of the GUI screen 1200 for the display of the viewing environment shown in FIG. 12.

It should be noted that, in selection of the viewing environment based on the evaluation value, a safety measure is performed. For example, a viewing environment departing from a recommended range in view of health damage such as fatigue of eyes is removed from targets of evaluation (i.e., calculation of the evaluation value Er) or the candidate selection. For example, in the case where “sense of presence” of the visual effects is considered as important, it is only necessary to calculate the evaluation value of the sense of presence with respect to each viewing environment is calculated in accordance with Expression (1) above and select a viewing environment n having a highest evaluation value Er[n] as a prime candidate. Here, further considering the health damage, as long as the evaluation value Er[n] of “fatigue resistance” departs from the recommended range even if its evaluation value of the sense of presence Er[n] with respect to the viewing environment n is a high value, a setting is made such that the viewing environment n thereof cannot be selected.

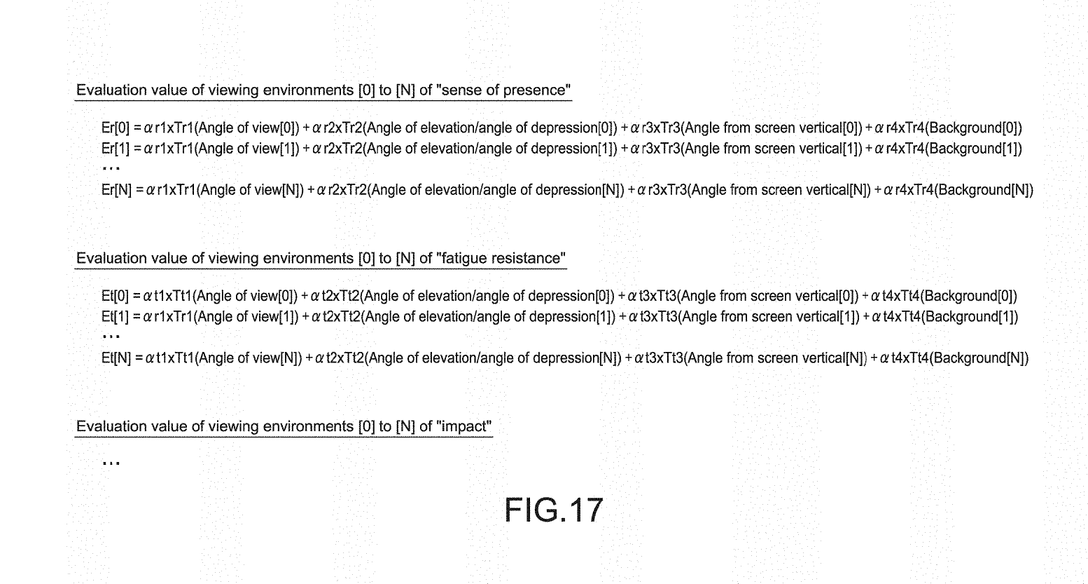

Further, as shown in FIG. 12, in order to present the correlation relationship between the viewing environment and the visual effect or the correlation relationship between the respective elements of the visual effect by using the radar chart 1231 and the bars 1232 in the visual effect display region 1230, it is necessary to calculate comprehensive evaluation values of the respective viewing environments regarding not only a particular element of the visual effect but also all elements. Expressions for calculating the comprehensive evaluation values of the respective viewing environments are shown in FIG. 17 regarding all elements of the visual effect. It should be noted that, in the expressions of FIG. 17, Ex[n] is an evaluation value of an element of a visual effect x with respect to the viewing environment n.

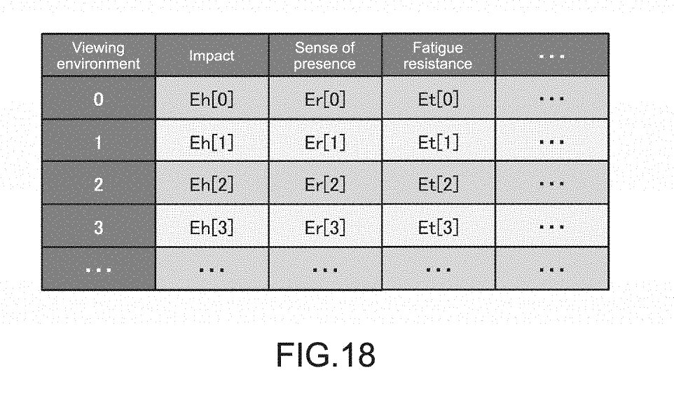

By calculating the comprehensive evaluation value of each viewing environment for each element of the visual effect as shown in FIG. 17, the table indicating an evaluation value of each element of the visual effect with respect to each viewing environment as shown in FIG. 18 can be obtained. In the figure, the numerical values described in the column of the viewing environment is serial numbers of the viewing environment. Each of the serial numbers corresponds to a combination of parameters that constitute that viewing environment in one-to-one correspondence.

When the viewing environment is selected in the viewing environment candidate display region 1220 or when the viewing environment is changed or controlled in the viewing environment display region 1210, an evaluation value in each element of the visual effect with respect to a newly selected viewing environment can be immediately obtained by referring to the table shown in the table shown in FIG. 18 and the display of the radar chart 1231 and the bars 1232 can be updated. That is, the display of the radar chart 1231 and the bars 1232 is, in real-time, in conjunction with the selection or change operation of the viewing environment.

Further, in the examples shown in FIG. 14 and FIG. 16, the evaluation value table of the visual effect is set in each parameter of the viewing environment. In the case where a combination of the parameters of the parameters of the viewing environment complexly influence the visual effect (in the case of complexly influencing a particular element of the visual effect), an evaluation value table of the visual effect with respect to a combination of two or more parameters of the viewing environment may be set.

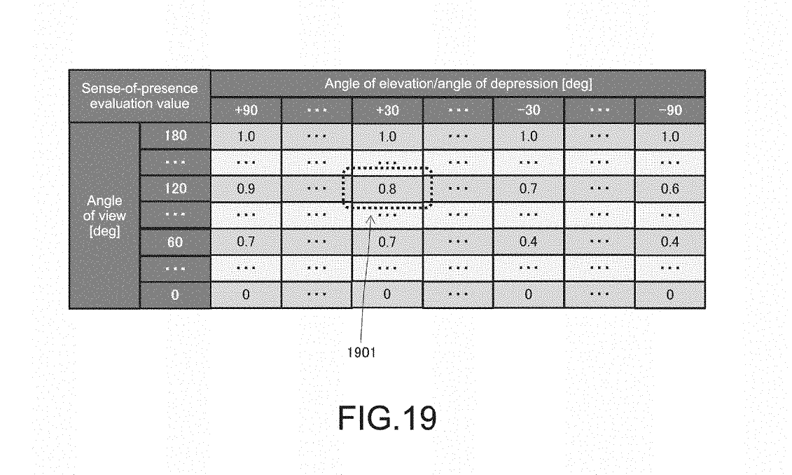

FIG. 19 shows a configuration example of the evaluation value table of the visual effect “sense of presence” with respect to a viewing environment combining two parameters that are the angle of view and the angle of elevation/angle of depression. Trnm (X, Y) means the evaluation value of the visual effect with respect to X and Y values of a combination of two parameters of the viewing environment in the evaluation value table shown in FIG. 19. For example, the evaluation value of the visual effect with respect to the viewing environment which is denoted by a reference number 1901 is Tr12 (120, 30)=0.8.

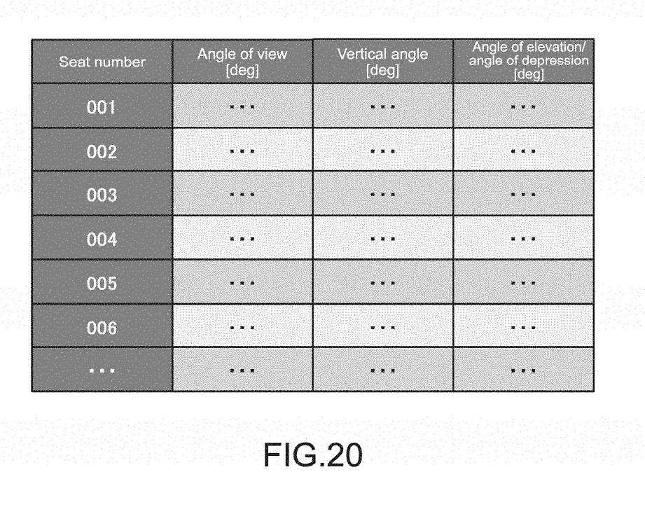

Further, in the example shown in FIG. 13, the viewing environment is expressed utilizing the seat map of the movie theater (or facility such as music hall and theater) in the viewing environment display region 1300 (as described above). In this case, each seat on the seat map uniquely corresponds to a combination of the parameters of the viewing environment as the screen is observed using it as the viewpoint position. FIG. 20 illustrates a table describing a correspondence relationship between a seat number and each parameter of the viewing environment. The seat number corresponds to a combination of parameters that constitute the viewing environment in one-to-one correspondence.

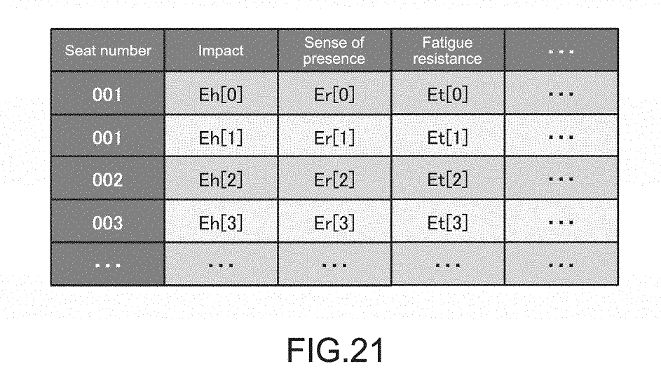

In such a case, the comprehensive evaluation value of the visual effect with respect to the viewing environment is calculated for each seat number. In this manner, a table indicating the evaluation value for each element of the visual effect with respect to the seat number as shown in FIG. 21 can be obtained. It can also be said that the evaluation value table shown in FIG. 21 is a modified example of the evaluation value table shown in FIG. 19 because it describes the relationship of the evaluation values of the visual effect with respect to the combination of the two or more parameters that constitute the viewing environment.

Further, a seat as a candidate is selected in the viewing environment candidate display region or a change operation of the seat position is made in the viewing environment display region (see FIG. 13) utilizing the seat map. Then, in the visual effect display region, the display can be immediately changed to the evaluation value regarding each element of the visual effect with respect to the viewing environment corresponding to the seat by referring to the evaluation value table shown in FIG. 21.

Not only a viewing environment but also a configuration of an image to be viewed influence a visual effect (as described above). Examples of the image configuration include a composition, largeness of a motion, and a presentation position of character information such as a subtitle. The image configurations are roughly classified on the basis of content genres (movies, sports, news, etc.). In addition, the image configurations can be finely classified for each content.

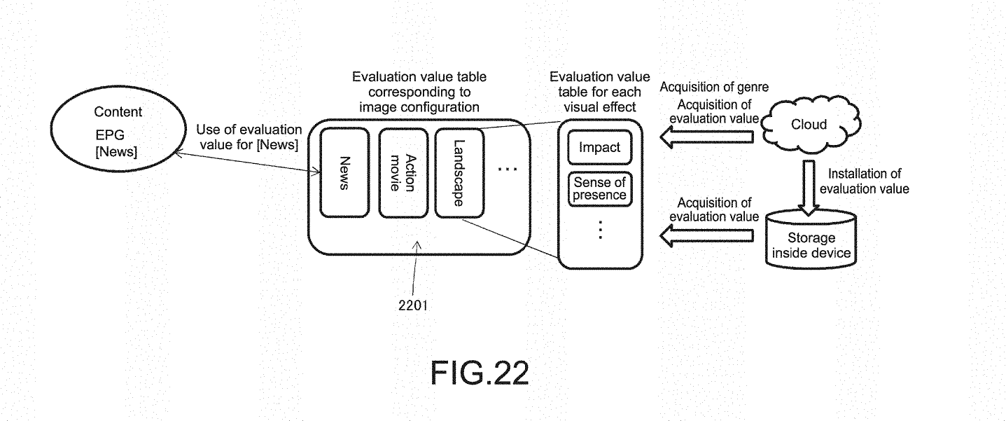

In each of FIGS. 14 and 16, the example in which the evaluation value table of the visual effect is set in each parameter of the viewing environment is shown. In order to perform selection of the viewing environment while considering the image configuration as well as the viewing environment, it is necessary to set an evaluation value table for each image configuration. FIG. 22 schematically shows a configuration example of a system in which the image configurations are classified on the basis of the content genre and an evaluation value table of the visual effect with respect to the viewing environment is set for each content genre. It should be understood that a structure of an evaluation value table 2201 set for each content genre in FIG. 22 is similar to that of the evaluation value table shown in FIG. 16. More fine-grained services can be realized by preparing the evaluation value table of the visual effect with respect to the viewing environment not for each content genre but for each individual content item. Note that, rather than preparing the evaluation value table of the visual effect with respect to the viewing environment for each content genre (or for each content), an alternative of preparing a table indicating an evaluation value of each element of the visual effect with respect to each viewing environment as shown in FIG. 18 can be made.

As shown in FIG. 22, by setting the evaluation value table for each content genre, it is possible to support an observer such that the observer can select an optimal viewing environment by using an evaluation value corresponding to a genre of content to be viewed.

In the case where content to be viewed is the broadcast program, a content genre can be estimated on the basis of a keyword contained in a program title or program information, by referring to an EPG (Electronic Program Guide) delivered in data broadcasting, for example. Alternatively, information for identifying the genre may be included in metadata associated with the content. Alternatively, information on respective content genres may be stored on a cloud in advance and the content genre may be acquired by accessing the cloud during selection of the viewing environment.

When accessing data broadcasting, metadata, or the cloud and estimating a content genre, an information processing apparatus that supports the observer's selection of the viewing environment is capable of performing calculation processing of the evaluation value of the visual effect with respect to the viewing environment by using an evaluation value table corresponding to that genre. Therefore, even if switching of channel of the broadcast program, exchange of a reproduction medium, or the like is performed, it is possible to adaptively perform calculation of the evaluation value of the visual effect with respect to the viewing environment and support an observer such that the observer can easily select a viewing environment optimal for the content genre.

In the system as shown in FIG. 22, the number of evaluation value tables of the visual effect with respect to the viewing environment is equal to the number of content genres. Therefore, the amount of data is enormous as a whole. The evaluation value table of the visual effect with respect to the viewing environment may be pre-installed in the information processing apparatus that supports selection of the viewing environment. Alternatively, evaluation value tables of the visual effect with respect to the viewing environment may be stored on the cloud in advance and may be utilized by accessing the cloud from the information processing apparatus in a manner that depends on needs and performing a method, for example, additional installation or directly referring to the cloud.

Further, rather than setting the evaluation value table of the visual effect with respect to the viewing environment for each content genre, it may be set for each content. The content creator distributes the evaluation value table created by the content creator in data broadcasting such as EPG or stores it on the cloud. For example, the content creator creates an evaluation value table of the visual effect with respect to the viewing environment. In this manner, the content creator can induce observers to select the viewing environment that can reflect a creator's intention, to “wish observers to view content on a large screen” or to “wish observers to overlook content at a long distance”. Further, there is an advantage for observers that they can enjoy the content in the viewing environment according to the creator's intention.

Note that introducing a mechanism for acquiring the table of the visual effect with respect to the viewing environment from the cloud provides an advantage that diffusibility is enhanced in addition to an advantage that it becomes possible to address each content genre or an individual content item in a fine-grained manner. For example, it is possible to store evaluation value tables on the cloud for each critic with respect to the same content and present recommended viewing environments of the same content, which are different in a manner that depends on critics. Further, by storing, on the cloud, an evaluation table based on the latest research result regarding the visual effect of the viewing environment, it is possible to cause the latest research result to immediately reflect ordinary homes.

Further, the viewing environment can also be defined further including the background part outside the image in addition to respective parameters indicating how an image is seen, for example, the angle of view, the look-up angle or look-down angle, and the viewing angle from the screen center vertical as described above. Also regarding background data, the extensibility is enhanced in such a manner that the background data can be acquired from the cloud. It is possible to create a background optimal for each content category or an individual content item and distribute the created backgrounds via the cloud. Further, even in the case where the movie theater is the background image, background images including various movie theaters that actually exist as objects or movie theaters or the like produced by the content creator may be delivered via the cloud and each observer may select one of them in a manner that depends on preference of that observer. Further, a background image produced by an observer may be used and the produced background image may be delivered to other observers by storing the produced background image on the cloud.

The evaluation value table of the visual effect with respect to the viewing environment includes the coefficient of the degree of influence exerted on the visual effect by each parameter of the viewing environment. In order to reduce the work load of an observer in performing the fine control operation of the viewing environment, results of fine control and selection states of a plurality of candidates are learned and the degree-of-influence coefficient is successively updated. Such learning processing may be performed for each content genre or for each element of the visual effect. Alternatively, such learning processing may be performed throughout without being divided for each content genre or for each element of the visual effect.

### C. Learning Function

In order to cause differences of the human visual performance between individuals and the preference of the individuals to reflect selection of the viewing environment, an observer can perform the fine control operation of the viewing environment in the viewing environment display region as described above with reference to FIGS. 12 and 13. In order to reduce the work load in performing the fine control operation, a learning function of learning a result of the fine control or selection states of a plurality of candidates may be introduced and the coefficient of the degree of influence exerted on the visual effect by each parameter of the viewing environment may be successively updated. As a result of progress of learning, it becomes possible to rapidly select the viewing environment more suitable to observer's preference.

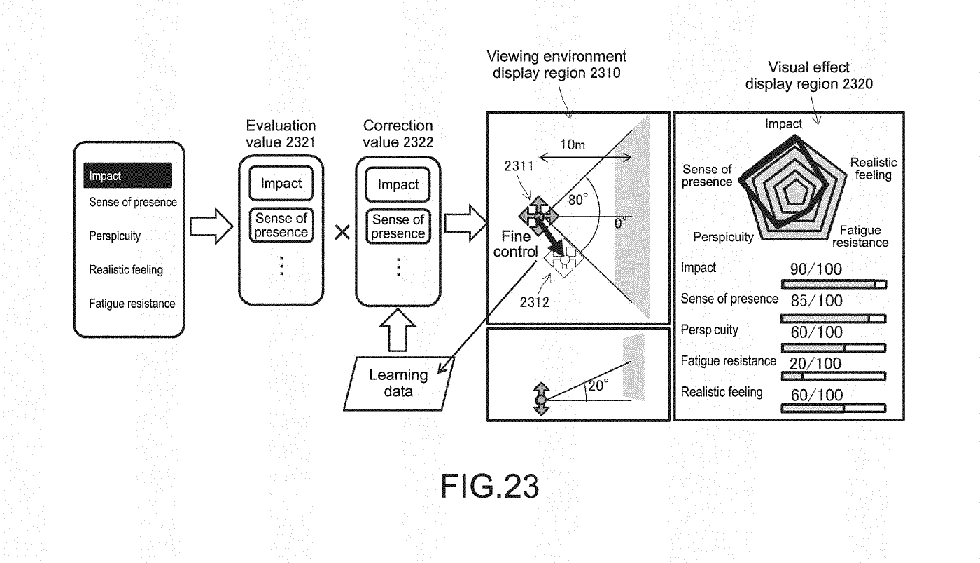

FIG. 23 explains a mechanism of learning a result of the observer's fine control operation of the viewing environment for evaluation value calculation of the visual effect.

For viewing content of the genre “movie”, an observer selects “impact” as a desired visual effect. Then, evaluation values of the visual effect “impact” with respect to the respective selectable viewing environments (respective seats in the case of utilizing a coordinate map of the movie theater) and other visual effects “sense of presence”, “perspicuity” . . . are calculated. Then, a viewing position extracted on the basis of the evaluation value of the visual effect “impact” is displayed in a viewing environment display region 2310, as denoted by a reference number 2311. Further, respective evaluation values of the visual effect calculated with respect to that viewing environment candidate are displayed in a visual effect display region 2320, using the radar chart and the bar, for example.

The viewing position 2311 is a cursor. An observer can further arbitrarily adjust the viewing position by operating the cursor (as described above). In the example shown in FIG. 23, it is assumed that the viewing position is adjusted to a viewing position 2312 in accordance with an observer's operation. The viewing position 2312 is located at a position when the viewing position is moved by x-meter(s) to the right and by y-meter(s) to the front.

The correction value for the evaluation value table or the degree-of-influence coefficient when adjustment is made by an observer from the viewing position 2311 to the viewing position 2312 is learned. A learning method is not particularly limited. For example, machine learning or a neural network may be employed.

Then, in the case of calculating the evaluation value at the next and succeeding times, the viewing position 2312 after adjusted by an observer is selected as a prime candidate of the viewing environment by multiplying an evaluation value 2321 obtained by referring to the evaluation value table of the viewing effect with respect to the viewing environment with a learned correction value 2322.

Learning information is personal information to be learned for each observer. The learning information is retained for each observer within storage of the information processing apparatus used in selection of the viewing environment, for example. Alternatively, the learning information for each observer may be stored on the cloud (see FIG. 22). In the latter case, it is necessary to determine the observer for acquiring the learning information when calculating the evaluation value of the visual effect with respect to the viewing environment. When acquiring the evaluation value table from the cloud, for example, at the start of the information processing apparatus or during reproduction, an observer may be expressly checked via a GUI or the like. Alternatively, by utilizing facial recognition using a camera, voice recognition using a microphone, and another living-body authentication technology, person identification may be performed without perception of an observer.

D. Other Factors that Influence Evaluation Value of Visual Effect

Hereinabove, two, the viewing environment and the image configuration have been exemplified as the factors that influence evaluation of the visual effect. In addition, it is conceivable that a relative relationship between an observer and a display device and an extrinsic factor also influences the evaluation of the visual effect.

In the case where the display device is a head-mounted display, it is an environment in which the observer's head is fixed and the relative relationship is not changed. Therefore, it is necessary to consider the relative relationship. In contrast, in the case where the display device is a television receiver or projector whose relative relationship with an observer changes, it is necessary to acquire a relative relationship with a current observer and take that relative relationship into consideration when calculating the evaluation value of the visual effect with respect to the viewing environment or the like.

Further, brightness of a room where an image is observed and a color temperature are exemplified as the extrinsic factor that influences the evaluation value of the visual effect with respect to the viewing environment or the like. Further, the human visual performance is changed in a manner that depends on a health state and states of the five senses excluding the sense of sight. Therefore, it is necessary to consider them as extrinsic factors. For example, temperature, humidity, a time zone, seasons, and the like are extrinsic factors that influence the evaluation value of the visual effect.

Those extrinsic factors are also useful for a means for creating the correction value of the learning function of the degree-of-influence coefficient described above. If information, for example, “to prefer viewing at a lower position than that of a presented viewing environment in a state in which the color temperature is higher” or “to prefer viewing at a lower position than that of a presented viewing environment in a late time zone” can be obtained, it is possible to rapidly present a more suitable viewing environment by acquiring environment information regarding the extrinsic factor in viewing and multiplying it with a suitable correction value.

### E. Another Example of Selection Method for Viewing Environment

In the selection method for the viewing environment described hereinabove, an element of the visual effect that is considered as important by an observer can be selected on the

GUI screen (e.g., see FIG. 11). An evaluation value of each viewing environment is calculated in accordance with Expression (1) above and a viewing environment whose evaluation value of a selected element of the visual effect is high is presented as a candidate (FIG. 12).

The calculation expression of the evaluation value of the visual effect with respect to the viewing environment as shown in Expression (1) above is for calculating the evaluation value in such a manner that an observer focuses on only a particular selected element of the visual effect.

As a modified example of the calculation expression of the evaluation value of the visual effect with respect to the viewing environment, a comprehensive evaluation value Epos[n] with respect to the viewing environment n which also includes the visual effect other than the selected element as shown in Expression (2) below is also conceived. The candidates of the viewing environment may be selected on the basis of the comprehensive evaluation value Epos[n].

[Expression 2]

Epos[n]=β1×Eh[n]+β2×Er[n]+β3×Et[n]+ . . . (2)

In Expression (2) above, Ex[n] is an evaluation value of an element x of the visual effect with respect to the viewing environment n. Further, β is a weighting coefficient of each element of the visual effect. As shown in Table 2 below, a weighting coefficient is prepared for each selected visual effect.

Also in the case of selecting a candidate of the viewing environment by utilizing the comprehensive evaluation value Epos[n] with respect to the viewing environment n which includes all elements of the visual effect shown in Expression (2) above, it is favorable to set a recommended range in the evaluation value regarding an element which can harm the health, for example, being easily fatigued in terms of health damage in order to prevent the viewing environment that departs from the recommended range from being selected.

Here, the selection method for the viewing environment based on the comprehensive evaluation value will be described. It should be noted that, for the sake of simplification of description, it is assumed that there are two viewing environments n=0, 1 and there are only three elements “impact”, “sense of presence”, and “fatigue resistance” as visual effects. Further, it is assumed that a weighting coefficient β of each visual effect is as shown in Table 3 below and evaluation values of individual elements of the visual effect with respect to the respective viewing environments are as shown in Table 4 below.

The comprehensive evaluation values Epos[0] and Epos[1] of the respective viewing environments are as shown in Expressions (3) and (4) below in the case of selecting “impact” as the visual effect considered as important by the observer. A higher evaluation value is obtained in the viewing environment n=0.

[Expression 3]

Epos[0]=1.0×0.7+0.6×0.8+0.4×0.5=1.38 (3)

[Expression 4]

Epos[1]=1.0×0.9+0.9×0.9+0.4×0.2=1.52 (4)

On the other hand, the comprehensive evaluation values Epos[0] and Epos[1] of the respective viewing environments in the case of selecting “fatigue resistance” as the visual effect considered as important by an observer are as shown in Expressions (5) and (6) below. A higher evaluation value is obtained in the viewing environment n=1.

[Expression 5]

Epos[0]=0.4×0.7+0.4×0.8+01.0×0.5=1.1 (5)

[Expression 6]

Epos[1]=0.4×0.9+0.4×0.9+10×0.2=0.92 (6)

Also in the case of calculating the comprehensive evaluation value of the visual effect with respect to the viewing environment as shown in Expression (2) above, how to take the evaluation value of the visual effect for each content genre (or for each content) is different. Therefore, the evaluation value table for each element of the visual effect with respect to each parameter of the viewing environment as shown in FIG. 16 has to be prepared for each content genre (or for each content). Alternatively, a table indicating an evaluation value of each element of the visual effect with respect to each viewing environment as shown in FIG. 18 may be prepared for each content genre (or for each content).

In addition, in the method of evaluating the viewing environment on the basis of the comprehensive evaluation value of the visual effect with respect to the viewing environment, only one kind of table indicating an evaluation value of each element of the visual effect with respect to each viewing environment as shown in FIG. 18 may be prepared and a weighting coefficient used in the calculation expression of the comprehensive evaluation value shown in Expression (2) above may be prepared for each content genre (or for each content). In Table 5 below, one kind of evaluation value table regarding each viewing environment for each element of the visual effect is shown. Further, Tables 6 to 8 illustrate a weighting coefficient table for each content genre (movie, landscape, and news).

### F. System Configuration

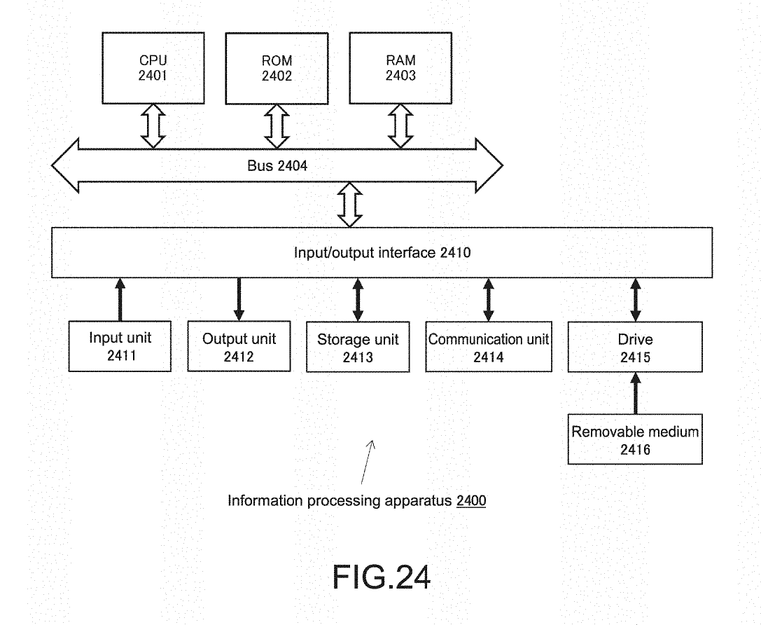

FIG. 24 shows a system configuration example of an information processing apparatus 2400 that realizes processing of supporting selection of an optimal viewing environment by presenting a GUI screen as shown in FIGS. 11 to 13.

A CPU (Central Processing Unit) 2401 executes a program stored in a ROM (Read Only Memory) 2402 or a program loaded into a RAM (Random Access Memory) 2403 from a storage unit 613 to be described later and realizes various types of processing. Further, the RAM 2403 is used as a work memory that appropriately stores necessary data for the CPU 2401 to execute various types of processing. The CPU 2401 executes an application program that realizes the processing of supporting selection of an optimal viewing environment, for example.

The CPU 2401, the ROM 2402, and the RAM 2403 are connected to one another via a bus 2404. An input/output interface 2410 is also connected to this bus 2404.

An input unit 2411, an output unit 2412, a storage unit 2413, a communication unit 2414, and the like are connected to the input/output interface 2410.

The input unit 2411 is constituted of a device that receives user's input operations, such as a keyboard, a mouse, and a touch panel.

The output unit 2412 constituted of a display apparatus such as a liquid crystal display (LCD) and a device such as a speaker. Alternatively, the output unit 2412 connects an external display device such as a head-mounted display, a television receiver, and a projector via an interface cable such as an HDMI (registered trademark) (High Definition Multimedia Interface).

The storage unit 2413 is constituted of a mass storage apparatus such as a hard disk drive an SSD (Solid State Drive) and saves programs and various data files executed by the CPU 2401. For example, in the storage unit 2413, an application program for realizing for example, the processing of supporting selection of an optimal viewing environment is installed. Further, the evaluation value table of the visual effect with respect to the viewing environment, the degree-of-influence coefficient of each parameter of the viewing environment, learned correction values, and the like may be saved in the storage unit 2413.

The communication unit 2414 is constituted of a network interface and connected to a wide range network such as the Internet via a LAN (Local Area Network) and performs communication processing. For example, data necessary for realizing the processing of supporting selection of an optimal viewing environment, such as the evaluation value table of the visual effect with respect to the viewing environment and the degree-of-influence coefficient of each parameter of the viewing environment that are managed on the cloud, can be acquired via the communication unit 2414. Further, a computer program acquired by the communication unit 2414 via the network can be installed in the storage unit 2413.

Further, a drive 2415 that accesses a removable medium 2416 is connected to the input/output interface 2410 in a manner that depends on needs. As the removable medium 2416 set forth herein, there can be exemplified a magnetic disk, an optical disc (CD-ROM (Compact Disc-Read Only Memory), a DVD (Digital Versatile Disc), etc.), a magneto-optical disk (MD (Mini Disc), etc.), or a semiconductor memory. For example, a computer program read out of the removable medium 2416 mounted on the drive 2415 is installed in the storage unit 2413 in a manner that depends on needs.

For example, data files of the application program for realizing the processing of supporting selection of an optimal viewing environment, the evaluation value table of the visual effect with respect to the viewing environment, the degree-of-influence coefficient of each parameter of the viewing environment, and the like can be provided in the form of the removable medium 2416 and installed in the information processing apparatus 2400.

It may be a program whose processes are sequentially performed in a predetermined order executed by the information processing apparatus 2400 or may be a program whose processes are performed concurrently or at a necessary timing, for example, upon calling. Further, further, the step describing the program recorded on the recording medium includes processing performed time-sequentially in a predetermined order. The processing does not necessarily need to be processed time-sequentially. The step describing the program recorded on the recording medium also includes processing to be concurrently or individually executed.

The information processing apparatus 2400 is configured as a personal computer or a tablet terminal, for example. Alternatively, the information processing apparatus 2400 may be a smartphone or a game console.

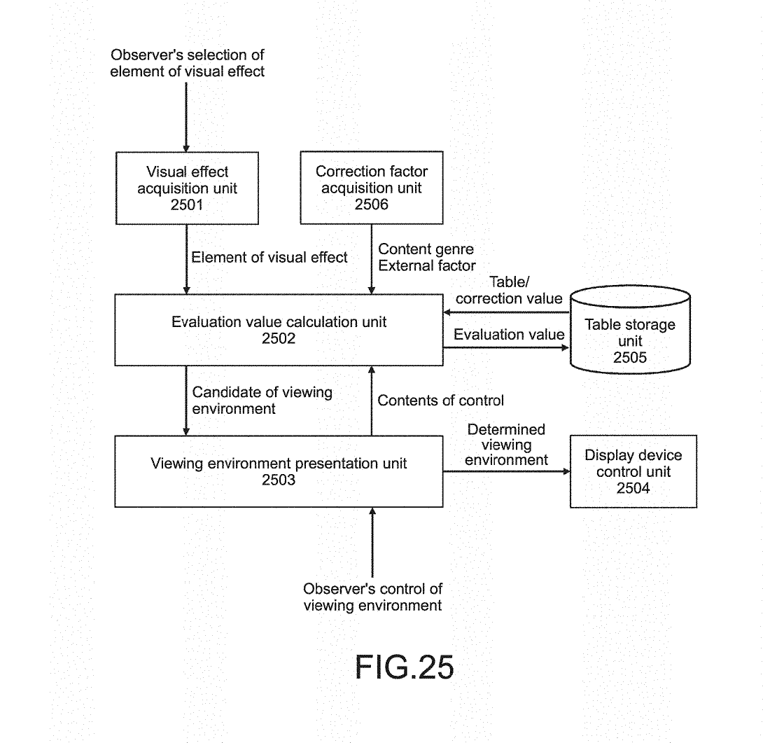

FIG. 25 schematically shows functional configurations for realizing the processing of supporting selection of an optimal viewing environment in the information processing apparatus 2400.

A visual effect acquisition unit 2501 acquires information regarding an element of the visual effect that is desired by the observer. The visual effect acquisition unit 2501 displays, for example, the GUI screen as shown in FIG. 11, inquires an element of the viewing effect that is desired (or considered as important) for content which will be now viewed by the observer, and outputs an element selected by the observer.

An evaluation value calculation unit 2502 calculates an evaluation value of each viewing environment regarding the visual effect acquired in the visual effect acquisition unit 2501. In a table storage unit 2505, data necessary for calculating the evaluation value of the visual effect with respect to the viewing environment, such as the evaluation value table of the visual effect with respect to the viewing environment and the degree-of-influence coefficient of each parameter of the viewing environment, is stored. The evaluation value calculation unit 2502 appropriately acquires necessary evaluation value table and degree-of-influence coefficient from the table storage unit 2505. The evaluation value calculation unit 2502 calculates an evaluation value of each viewing environment regarding the visual effect acquired in the visual effect acquisition unit 2501. The evaluation value calculation unit 2502 acquires suitable evaluation value table and degree-of-influence coefficient, also considering a content genre of a viewing target. Then, the visual effect acquisition unit 2501 sorts candidates from a viewing environment having a higher evaluation value and outputs the sorted candidates to a viewing environment presentation unit 2503.

The viewing environment presentation unit 2503 presents the candidates of the viewing environment that are sorted by the evaluation value calculation unit 2502 to an observer. The viewing environment presentation unit 2503 displays the candidates of the viewing environment, using, for example, a GUI screen as shown in FIGS. 12 and 13. That is, the viewing environment presentation unit 2503 displays a list of the candidates of the viewing environment in the viewing environment candidate display region and maps and displays each parameter of the viewing environment that is selected by the observer from it in the viewing space in the viewing environment display region. Further, the viewing environment presentation unit 2503 displays the evaluation values of the respective elements of the visual effect in the viewing environment currently specified in the viewing environment display region, in the visual effect display region. The evaluation values of respective elements of the visual effect in the viewing environment are displayed using the radar chart and the bar. Therefore, the perspicuity is enhanced. It thus becomes easy for an observer to intuitively understand the correlation relationship between the viewing environment and the visual effect or the correlation relationship between the respective elements of the visual effect.

Further, when an observer changes or controls the viewing environment, the viewing environment presentation unit 2503 changes the display of the viewing environment in the viewing environment display region. Further, the viewing environment presentation unit 2503 feeds back the adjusted contents of the viewing environment to the evaluation value calculation unit 2502. The evaluation value calculation unit 2502 re-calculates the evaluation value of the visual effect in the viewing environment after the change and outputs the evaluation value to the viewing environment presentation unit 2503 and the viewing environment presentation unit 2503 causes the visual effect display region to reflect it.

Here, in the case of utilizing the learning function, a correction factor acquisition unit 2506 acquires information on factors other than the viewing environment which influence the evaluation of the visual effect, for example, information on an extrinsic factor, a content genre, and observer's visual performance. Then, the evaluation value calculation unit 2502 associates the correction value of the degree-of-influence coefficient due to the control of the viewing environment with the extrinsic factor, the content genre, the visual performance of each observer, and the like and causes the table storage unit 2505 to store the correction value. Further, when calculating the evaluation value of the visual effect with respect to the viewing environment, the evaluation value calculation unit 2502 obtains the correction factor such as an external environment in execution of calculation from the correction factor acquisition unit 2506. Then, the correction value corresponding to it is read from the table storage unit 2505. The evaluation value table of the visual effect with respect to the viewing environment and the degree-of-influence coefficient of each parameter of the viewing environment are corrected with the correction value. After that, calculation of the evaluation value is executed.

Then, the viewing environment presentation unit 2503 outputs, to a display device control unit 2504, information including each parameter value of the viewing environment the observer's selection of which has been determined. The display device control unit 2504 makes control to realize the viewing environment on the screen displayed by a display device as a control target such as a head-mounted display, a television receiver, and a projector.

Note that the function modules 2501 to 2504 in FIG. 25 are realized in such a manner that the CPU 2401 executes a program code in the information processing apparatus 2400. Further, the substance of the table storage unit 2504 is the cloud (not shown) accessed via, for example, the storage unit 2413, the removable medium 2416, or the communication unit 2414.

Further, the functional configurations for realizing the processing of supporting selection of an optimal viewing environment as shown in FIG. 25 may be incorporated in a display device itself as a control target of the viewing-environment such as a head-mounted display, a television receiver, and a projector rather than being mounted on an apparatus independent of a display device, such as a personal computer.

### G. System Operation

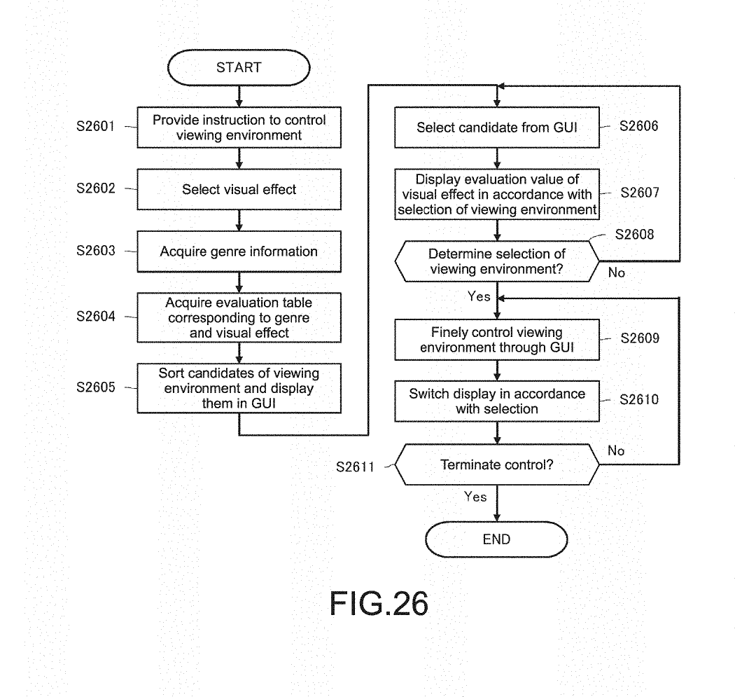

FIG. 26 is a flowchart showing a processing procedure for supporting selection of an optimal viewing environment by a content observer. This processing procedure is executed in the information processing apparatus 2400 shown in, for example, FIG. 24. Alternatively, a display device itself (head-mounted display, television receiver, projector, or the like) as a control target of the viewing-environment is executed.

For example, when an observer tries to start to view content (or when the observer is viewing the content), the observer provides an instruction to control the viewing environment (Step S2601). Then, a GUI screen for selecting an element of the visual effect that is desired (or considered as important) as shown in FIG. 11 is presented. The visual effect acquisition unit 2501 acquires an element of the visual effect that is selected by the observer via the GUI screen and outputs the acquired element of the visual effect to the evaluation value calculation unit 2502 (Step S2602).

Subsequently, the evaluation value calculation unit 2502 acquires genre information of the content to be viewed by the observer (Step S2603). For example, in the case where the content is a broadcast program, the content genre can be determined by analyzing the corresponding EPG information.

Subsequently, the evaluation value calculation unit 2502 acquires, from the table storage unit 2505, an evaluation value table of the selected element of the visual effect and a degree-of-influence coefficient, which are prepared for each content genre (Step S2604).

The evaluation value calculation unit 2502 calculates, on the basis of the acquired evaluation value table, evaluation values regarding the selected element of the visual effect with respect to the respective viewing environments and sorts candidates from a viewing environment having a higher evaluation value. Then, the viewing environment presentation unit 2503 presents to the observer the candidates of the viewing environment that are sorted by the evaluation value calculation unit 2502 using, for example, a GUI screen as shown in FIGS. 12 and 13 (Step S2605). A list of the candidates of the viewing environment is displayed on the GUI screen and the observer selects a desired viewing environment from it (Step S2606).

The viewing environment presentation unit 2503 maps and displays each parameter of the viewing environment that is selected by the observer, in the viewing space. Further, the viewing environment presentation unit 2503 displays the evaluation values of the respective elements of the visual effect in the viewing environment currently specified in the viewing environment display region of the GUI screen, in the visual effect display region (Step S2607). The evaluation values of respective elements of the visual effect in the viewing environment are displayed using the radar chart and the bar. Therefore, the perspicuity is enhanced. It thus becomes easy for the observer to intuitively understand the correlation relationship between the viewing environment and the visual effect or the correlation relationship between the respective elements of the visual effect.

Further, if the observer determines the selection of the viewing environment (Yes of Step S2608), the observer further directly operates that viewing environment on the GUI screen, such that that viewing environment can be changed or controlled (Step S2609).

The evaluation value calculation unit 2502 re-calculates the evaluation value of the visual effect in the viewing environment after the change and outputs the re-calculated evaluation value to the viewing environment presentation unit 2503 and the viewing environment presentation unit 2503 causes the visual effect display region to reflect it (Step S2610). Then, the control is terminated (Yes of Step S2611). Then, this processing routine is terminated.

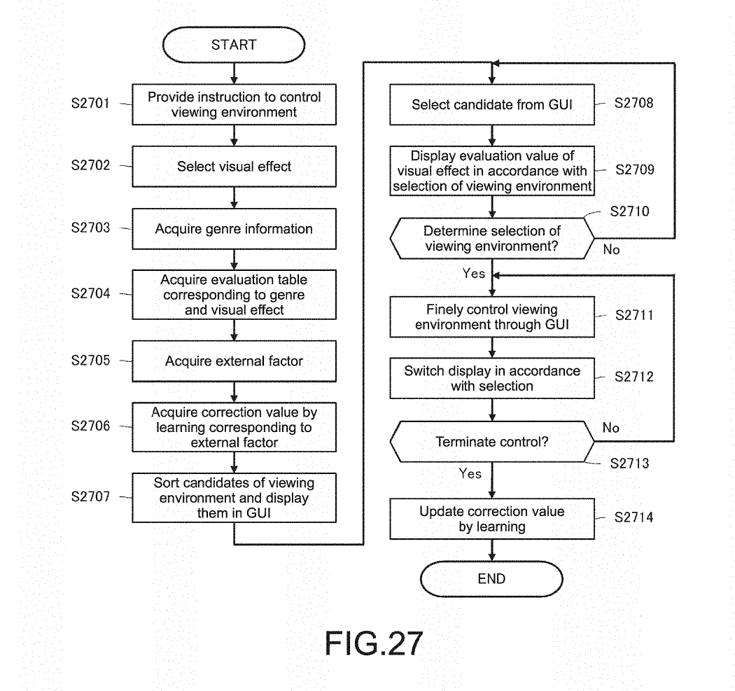

Further, FIG. 27 is a flowchart showing another example of the processing procedure for supporting selection of an optimal viewing environment by a content observer. The processing procedure shown in FIG. 27 further has a function of performing learning while associating the correction values, which is obtained by correcting the evaluation value table and the degree-of-influence coefficient so as to be closer to the viewing environment adjusted by an observer, with an extrinsic factor, observer's visual performance, and a content genre. This processing procedure is executed by the information processing apparatus 2400 shown in FIG. 24, for example. Alternatively, the processing procedure is executed by the display device (head-mounted display, television receiver, projector, or the like) itself as a control target of the viewing-environment.

For example, when an observer tries to start to view content (or when the observer is viewing the content), the observer provides an instruction to control the viewing environment (Step S2701). Then, a GUI screen for selecting an element of the visual effect that is desired (or considered as important) as shown in FIG. 11 is presented. The visual effect acquisition unit 2501 acquires an element of the visual effect that is selected by the observer via the GUI screen and outputs the acquired element of the visual effect to the evaluation value calculation unit 2502 (Step S2702).

Subsequently, the evaluation value calculation unit 2502 acquires genre information of the content to be viewed by the observer (Step S2703). For example, in the case where the content is a broadcast program, the content genre can be determined by analyzing the corresponding EPG information.

Subsequently, the evaluation value calculation unit 2502 acquires, from the table storage unit 2505, an evaluation value table of the selected element of the visual effect and a degree-of-influence coefficient, which are prepared for each content genre (Step S2704).

Further, the correction factor acquisition unit 2506 acquires information on factors other than the viewing environment which influence the evaluation of the visual effect, for example, information on an extrinsic factor, a content genre, and observer's visual performance (Step S2705).

Then, the evaluation value calculation unit 2502 further reads a correction value from the table storage unit 2505 by learning corresponding to the correction factor acquired in Step S2705 (Step S2706). The evaluation value calculation unit 2502 corrects the evaluation value table of the visual effect with respect to the viewing environment and the degree-of-influence coefficient of each parameter of the viewing environment, with the correction value. After that, the evaluation value calculation unit 2502 executes calculation of the evaluation value and sorts candidates from a viewing environment having a higher evaluation value. Then, the viewing environment presentation unit 2503 presents to the observer the candidates of the viewing environment that are sorted by the evaluation value calculation unit 2502 using, for example, a GUI screen as shown in FIGS. 12 and 13 (Step S2707). A list of the candidates of the viewing environment is displayed on the GUI screen and the observer selects a desired viewing environment from it (Step S2708).

The viewing environment presentation unit 2503 maps and displays each parameter of the viewing environment that is selected by the observer in the viewing space. Further, the viewing environment presentation unit 2503 displays the evaluation values of the respective elements of the visual effect in the viewing environment currently specified in the viewing environment display region of the GUI screen, in the visual effect display region (Step S2709). The evaluation values of respective elements of the visual effect in the viewing environment are displayed using the radar chart and the bar. Therefore, the perspicuity is enhanced. It thus becomes easy for the observer to intuitively understand the correlation relationship between the viewing environment and the visual effect or the correlation relationship between the respective elements of the visual effect.

Further, when determining selection of the viewing environment (Yes of Step S2710), the observer further directly operates that viewing environment on the GUI screen, such that that viewing environment can be changed or adjusted (Step S2711).

The evaluation value calculation unit 2502 re-calculates the evaluation value of the visual effect in the viewing environment after the change and outputs the re-calculated evaluation value to the viewing environment presentation unit 2503 and the viewing environment presentation unit 2503 causes the visual effect display region to reflect it (Step S2712).

Then, when the control is terminated (Yes of Step S2713), the evaluation value calculation unit 2502 associates the correction value of the degree-of-influence coefficient due to the control of the viewing environment with the extrinsic factor, the content genre, the visual performance of each observer, and the like and causes the table storage unit 2505 to store the correction value (Step S2714). After that, this processing routine is terminated.

### CITATION LIST

### Patent Literature

Patent Literature 1: Japanese Patent Application Laid-open No. 2013-218535

Patent Literature 2: Japanese Patent Application Laid-open No. HEI 7-114000

Patent Literature 3: Japanese Patent Application Laid-open No. 2012-44407

Patent Literature 4: US Patent No. 8549415

Patent Literature 5: Japanese Patent Application Laid-open No. HEI 9-146038, paragraph 0040, FIG. 22

### INDUSTRIAL APPLICABILITY

Hereinabove, the technology disclosed herein has been described in detail with reference to the particular embodiments. However, it is obvious that a person skilled in the art can achieve modifications and alternatives of those embodiments without departing from the gist of the technology disclosed herein.

The technology disclosed herein can support a viewer such that the viewer can select a display method for obtaining a suitable viewing environment with respect to a large-screen display such as a head-mounted display and a television receiver.

Further, the technology disclosed herein is also applicable to, for example, a seat reservation system of a movie theater, a music hall, or a theater. In this case, a user who will have a reservation can specify an optimal seat depending on the contents of a movie, artist's musical performance, a genre of a theatrical performance, or the like.

In short, the technology disclosed herein has been described in an illustrative form and the contents of description of the present specification should not be interpreted as being limitative. For judging the gist of the technology disclosed herein, the scope of claims should be considered.

Note that the technology of the disclosure of the present specification may also take the following configurations.

(1) An information processing apparatus, including:

a visual effect acquisition unit that acquires information on an element of a visual effect;

an evaluation value calculation unit that calculates an evaluation value of the acquired element of the visual effect with respect to a viewing environment or an image configuration and selects candidates of one or more viewing environments on the basis of an evaluation value; and

a viewing environment presentation unit that presents the viewing environment of the candidate.

(2) The information processing apparatus according to (1), in which

the visual effect acquisition unit presents a menu for selecting the element of the visual effect and acquires information on the element of the visual effect on the basis of a selection operation on the menu.

(3) The information processing apparatus according to either (1) or (2), in which

the viewing environment presentation unit displays each of the candidates of the viewing environment, which is selected by the evaluation value calculation unit, as a menu item.

(4) The information processing apparatus according to any of (1) to (3), in which

the viewing environment presentation unit displays each of the parameters which constitutes the currently selected viewing environment.

(5) The information processing apparatus according to (4), in which

the viewing environment presentation unit displays at least one of a screen size, a viewing distance, a look-up angle or look-down angle, and a viewing angle from a screen center vertical, as the parameter that constitutes the currently selected viewing environment.

(6) The information processing apparatus according to any of (1) to (5), in which

the viewing environment presentation unit displays a viewing position in a viewing space, which corresponds to a currently selected viewing environment.

(7) The information processing apparatus according to (5), in which

the viewing environment presentation unit displays at least one of the screen size, the viewing distance, and the horizontal angle of view from the viewing position, utilizing a top view of a viewing space.

(8) The information processing apparatus according to (5), in which

the viewing environment presentation unit displays at least one of the screen size and the look-up angle or look-down angle from the viewing position, utilizing a side view of a viewing space.

(9) The information processing apparatus according to either of (7) or (8), in which

the viewing environment presentation unit updates each of the parameters which constitutes a currently selected viewing environment, in conjunction with an operation of changing the viewing position.

(10) The information processing apparatus according to any of (1) to (9), in which

the viewing environment presentation unit displays an evaluation value of each element of the visual effect with respect to a currently selected viewing environment.

(11) The information processing apparatus according to any of (1) to (9), in which

the viewing environment presentation unit displays an evaluation value of each element of the visual effect with respect to the viewing environment that is the candidate, using at least one of a radar chart and a bar.

(12) The information processing apparatus according to either (10) or (11), in which

in conjunction with a change in selection of a viewing candidate, the evaluation value calculation unit re-calculates an evaluation value of a viewing effect with respect to the changed viewing candidate, and

the viewing environment presentation unit updates display of the evaluation value of each element of the visual effect on the basis of a result of the re-calculation by the evaluation value calculation unit.

(13) The information processing apparatus according to either (7) or (8), in which

in conjunction with an operation of changing the viewing position, the evaluation value calculation unit re-calculates an evaluation value of a viewing effect with respect to the changed viewing position, and

the viewing environment presentation unit updates display of the evaluation value of each element of the visual effect on the basis of a result of the re-calculation by the evaluation value calculation unit.

(14) The information processing apparatus according to any of (1) to (13), in which

the viewing environment presentation unit displays, utilizing a seat position in a seat map of a movie theater or another facility, a viewing environment (a screen size, a viewing distance, a look-up angle or look-down angle, and a viewing angle from a screen center vertical as a screen is observed using the seat position as a viewpoint position).

(15) The information processing apparatus according to any of (1) to (14), in which

the evaluation value calculation unit removes a viewing environment whose at least some parameters depart from a recommended range, from the candidate irrespective of superiority or inferiority of the evaluation value of the acquired element.

(16) The information processing apparatus according to any of (1) to (15), in which

the evaluation value calculation unit refers to an evaluation value table describing a relationship between evaluation values of respective elements of the visual effect with respect to each viewing environment and calculates an evaluation value of an element of the visual effect with respect to a viewing environment.

(17) The information processing apparatus according to (16), in which

the evaluation value calculation unit refers to the evaluation value table in which influence exerted on each element of the visual effect is quantified as the evaluation value for each parameter of the viewing environment.

(18) The information processing apparatus according to (16), in which

the evaluation value calculation unit performs weighting addition on the evaluation value of the element of the visual effect with respect to each parameter of the viewing environment using a weight coefficient for each parameter and calculates a comprehensive evaluation value for each element of the visual effect with respect to the viewing environment.

(18-1) The information processing apparatus according to (18), in which

the evaluation value calculation unit uses a weight coefficient corresponding to an element acquired by the visual effect acquisition unit.

(19) An information processing method, including:

a visual effect acquisition step of acquiring information on an element of a visual effect;

an evaluation value calculation step of calculating an evaluation value of the acquired element of the visual effect with respect to a viewing environment or an image configuration and selecting candidates of one or more viewing environments on the basis of an evaluation value; and

a viewing environment presentation step of presenting the viewing environment of the candidate.

(20) A computer program described in a computer-readable format that causes a computer to functions as:

a visual effect acquisition unit that acquires information on an element of a visual effect;

an evaluation value calculation unit that calculates an evaluation value of the acquired element of the visual effect with respect to a viewing environment or an image configuration and selects candidates of one or more viewing environments on the basis of an evaluation value; and

a viewing environment presentation unit that presents the viewing environment of the candidate.

(21) The information processing apparatus according to (16), in which

the parameter of the viewing environment includes at least one of an angle of view, an angle of elevation/angle of depression, a vertical angle, and a background.

(22) The information processing apparatus according to (16), in which

the element of the visual effect includes at least one of an impact, a sense of presence, a perspicuity, a realistic feeling, and fatigue resistance, as the element of the visual effect.

(23) The information processing apparatus according to (16), in which

the evaluation value table describes a relationship between evaluation values of the visual effect with respect to a combination of two or more parameters that constitute the viewing environment.

(24) The information processing apparatus according to (1), in which

the parameter of the image configuration includes at least one of a composition, largeness of motion, and a presentation position of character information such as a subtitle.

(25) The information processing apparatus according to (1), in which

the evaluation value calculation unit refers to an evaluation value table that describes a relationship between the evaluation values of the respective elements of the visual effect with respect to the viewing environment that are set for each image configuration and calculates the evaluation value of the element of the visual effect that conforms to the image configuration.

(26) The information processing apparatus according to (1), in which

classifies the image configuration on the basis of a content genre, refers to the evaluation value table describing the relationship between the evaluation values of the respective elements of the visual effect with respect to the viewing environment which is set for each content genre, and calculates the evaluation value of the element of the visual effect that conforms to the content.

### REFERENCE SIGNS LIST

2401 . . . CPU, 2402 . . . RPM, 2403 . . . RAM

2404 . . . bus, 2410 . . . input/output interface

2411 . . . input unit, 2412 . . . output unit, 2413 . . . storage unit

2414 . . . communication unit

2415 . . . drive, 2416 . . . removable medium

2501 . . . visual effect acquisition unit,

2502 . . . evaluation value calculation unit

2503 . . . viewing environment presentation unit,

2504 . . . display device control unit

2505 . . . table storage unit, 2506 . . . correction factor acquisition unit

1. An information processing apparatus, comprising:
a visual effect acquisition unit that acquires information on an element of a visual effect;
an evaluation value calculation unit that calculates an evaluation value of the acquired element of the visual effect with respect to a viewing environment or an image configuration and selects candidates of one or more viewing environments on the basis of an evaluation value; and
a viewing environment presentation unit that presents the viewing environment of the candidate.

2. The information processing apparatus according to claim 1, wherein
the visual effect acquisition unit presents a menu for selecting the element of the visual effect and acquires information on the element of the visual effect on the basis of a selection operation on the menu.

3. The information processing apparatus according to claim 1, wherein
the viewing environment presentation unit displays each of the candidates of the viewing environment, which is selected by the evaluation value calculation unit, as a menu item.

4. The information processing apparatus according to claim 1, wherein
the viewing environment presentation unit displays each of the parameters which constitutes the currently selected viewing environment.

5. The information processing apparatus according to claim 4, wherein
the viewing environment presentation unit displays at least one of a screen size, a viewing distance, a look-up angle or look-down angle, and a viewing angle from a screen center vertical, as the parameter that constitutes the currently selected viewing environment.

6. The information processing apparatus according to claim 1, wherein
the viewing environment presentation unit displays a viewing position in a viewing space, which corresponds to a currently selected viewing environment.

7. The information processing apparatus according to claim 5, wherein
the viewing environment presentation unit displays at least one of the screen size, the viewing distance, and the horizontal angle of view from the viewing position, utilizing a top view of a viewing space.

8. The information processing apparatus according to claim 5, wherein
the viewing environment presentation unit displays at least one of the screen size and the look-up angle or look-down angle from the viewing position, utilizing a side view of a viewing space.

9. The information processing apparatus according to claim 7, wherein
the viewing environment presentation unit updates each of the parameters which constitutes a currently selected viewing environment, in conjunction with an operation of changing the viewing position.

10. The information processing apparatus according to claim 1, wherein
the viewing environment presentation unit displays an evaluation value of each element of the visual effect with respect to a currently selected viewing environment.

11. The information processing apparatus according to claim 1, wherein
the viewing environment presentation unit displays an evaluation value of each element of the visual effect with respect to the viewing environment that is the candidate, using at least one of a radar chart and a bar.

12. The information processing apparatus according to claim 10, wherein
in conjunction with a change in selection of a viewing candidate, the evaluation value calculation unit re-calculates an evaluation value of a viewing effect with respect to the changed viewing candidate, and
the viewing environment presentation unit updates display of the evaluation value of each element of the visual effect on the basis of a result of the re-calculation by the evaluation value calculation unit.

13. The information processing apparatus according to claim 7, wherein
in conjunction with an operation of changing the viewing position, the evaluation value calculation unit re-calculates an evaluation value of a viewing effect with respect to the changed viewing position, and
the viewing environment presentation unit updates display of the evaluation value of each element of the visual effect on the basis of a result of the re-calculation by the evaluation value calculation unit.

14. The information processing apparatus according to claim 1, wherein
the viewing environment presentation unit displays, utilizing a seat position in a seat map of a movie theater or another facility, a viewing environment (a screen size, a viewing distance, a look-up angle or look-down angle, and a viewing angle from a screen center vertical as a screen is observed using the seat position as a viewpoint position).

15. The information processing apparatus according to claim 1, wherein
the evaluation value calculation unit removes a viewing environment whose at least some parameters depart from a recommended range, from the candidate irrespective of superiority or inferiority of the evaluation value of the acquired element.

16. The information processing apparatus according to claim 1, wherein
the evaluation value calculation unit refers to an evaluation value table describing a relationship between evaluation values of respective elements of the visual effect with respect to each viewing environment and calculates an evaluation value of an element of the visual effect with respect to a viewing environment.

17. The information processing apparatus according to claim 16, wherein
the evaluation value calculation unit refers to the evaluation value table in which influence exerted on each element of the visual effect is quantified as the evaluation value for each parameter of the viewing environment.

18. The information processing apparatus according to claim 16, wherein
the evaluation value calculation unit performs weighting addition on the evaluation value of the element of the visual effect with respect to each parameter of the viewing environment using a weight coefficient for each parameter and calculates a comprehensive evaluation value for each element of the visual effect with respect to the viewing environment.

19. An information processing method, comprising:
a visual effect acquisition step of acquiring information on an element of a visual effect;
an evaluation value calculation step of calculating an evaluation value of the acquired element of the visual effect with respect to a viewing environment or an image configuration and selecting candidates of one or more viewing environments on the basis of an evaluation value; and
a viewing environment presentation step of presenting the viewing environment of the candidate.

20. A computer program described in a computer-readable format that causes a computer to functions as:
a visual effect acquisition unit that acquires information on an element of a visual effect;
an evaluation value calculation unit that calculates an evaluation value of the acquired element of the visual effect with respect to a viewing environment or an image configuration and selects candidates of one or more viewing environments on the basis of an evaluation value; and
a viewing environment presentation unit that presents the viewing environment of the candidate.
